(19) United States
(12) Patent Application Publication
(10) Pub. No.: US 2005/0175183 A1
(43) Pub. Date: Aug. 11, 2005

(54) Method and architecture for secure transmission of data within optical switched networks

(76) Inventors: Shlomo Ovadia, San Jose, CA (US); Christian Maciocco, Tigard, OR (US)

Correspondence Address: R. Alan Burnett;BLAKELY, SOKOLOFF, TAYLOR & ZAFMAN LLP, Seventh Floor, 12400 Wilshire Boulevard, Los Angeles, CA, 90025-1026, US

(21) Appl. No.: 10/774,813

(22) Filed: Feb. 9, 2004

(51) Int. Cl. H04L 9/32; G06F 12/14

(52) U.S. Cl. 380/278; 713/201; 726/6

(57) ABSTRACT

A method and architecture for secure transmission of data within optical switched networks. In one embodiment, the optical switched network comprises a photonic burst-switched (PBS) network. Under various schemes, security keys are distributed to each edge node in a PBS network. A source edge node uses an encryption key to encrypt selected data bursts to be sent to a destination edge node via a virtual lightpath coupling the source and destination edge nodes. Security data are embedded in a control burst header indicates to the destination node whether corresponding data bursts sent via the virtual lightpath are encrypted. The security data may also identify an encryption/decryption algorithm and decryption keys to be used. Keys and/or certificates may be generated by or provided to the edge nodes. In some embodiments, public key infrastructure facilities are used in conjunction with employment of private and public keys and certificates.

### CROSS REFERENCE TO RELATED APPLICATIONS

The present application is related to U.S. patent application Ser. No. 8/126,091, filed Apr. 17, 2002; U.S. patent application Ser. No. 8/183,111, filed Jun. 25, 2002; U.S. patent application Ser. No. 10/328,571, filed Dec. 24, 2002; U.S. patent application Ser. No. 8/377,312 filed Feb. 28, 2003; U.S. patent application Ser. No. 8/377,580 filed Feb. 28, 2003; U.S. patent application Ser. No. 8/417,823 filed Apr. 16, 2003; U.S. patent application Ser. No. 8/417,487 filed Apr. 17, 2003; U.S. patent application Ser. No. (Attorney Docket No. 42P16183) filed May 19, 2003, U.S. patent application Ser. No. (Attorney Docket No. 42P16552) filed Jun. 18, 2003, U.S. patent application Ser. No. (Attorney Docket No. 42P16847) filed Jun. 24, 2003, U.S. patent application Ser. No. (Attorney Docket No. 42P17373) filed Aug. 6, 2003, and U.S. patent application Ser. No. (Attorney Docket No. 42P17541) filed Oct. 22, 2003.

### FIELD OF THE INVENTION

Embodiments of the present invention relate to optical networks in general; and, more specifically, to techniques for secure transmission of data with optical switched networks.

### BACKGROUND INFORMATION

Transmission bandwidth demands in telecommunication networks (e.g., the Internet) appear to be ever increasing and solutions are being sought to support this bandwidth demand. One solution to this problem is to use fiber-optic networks, where wavelength-division-multiplexing (WDM) technology enables the same physical link to transport multiple pieces of data concurrently.

Conventional optical switched networks typically use wavelength routing techniques, which require that optical-electrical-optical (O-E-O) conversion of optical signals be done at the optical switches. O-E-O conversion at each switching node in the optical network is not only a very slow operation (typically about ten milliseconds), but it is very costly, and potentially creates a traffic bottleneck for the optical switched network. In addition, the current optical switch technologies cannot efficiently support “bursty” traffic that is often experienced in packet communication applications (e.g., the Internet).

A large communication network can be implemented using several sub-networks. For example, a large network to support Internet traffic can be divided into a large number of relatively small access networks operated by Internet service providers (ISPs), which are coupled to a number of metropolitan area networks (Optical MANs), which are in turn coupled to a large “backbone” wide area network (WAN). The optical MANs and WANs typically require a higher bandwidth than local-area networks (LANs) in order to provide an adequate level of service demanded by their high-end users. Furthermore, as LAN speeds/bandwidth increase with improved technology, there is a corresponding need for increasing MAN/WAN speeds/bandwidth.

Recently, optical burst switching (OBS) schemes have emerged as a promising solution to support high-speed bursty data traffic over WDM optical networks. The OBS scheme offers a practical opportunity between the current optical circuit-switching and the emerging all optical packet switching technologies. It has been shown that under certain conditions, the OBS scheme achieves high-bandwidth utilization and class-of-service (CoS) by elimination of electronic bottlenecks as a result of the O-E-O conversion occurring at switching nodes, and by using a one-way end-to-end bandwidth reservation scheme with variable time slot duration provisioning scheduled by the ingress nodes. Optical switching fabrics are attractive because they offer at least one or more orders of magnitude lower power consumption with a smaller form factor than comparable O-E-O switches. However, most of the recently published work on OBS networks focuses on the next-generation backbone data networks (i.e. Internet wide network) using high capacity (i.e., 1 Tb/s) WDM switch fabrics with a large number of input/output ports (i.e., 256×256), optical channels (i.e., 40 wavelengths), and requiring extensive buffering. Thus, these WDM switches tend to be complex and very expensive to manufacture. In contrast, there is a growing demand to support a wide variety of bandwidth-demanding applications such as storage and/or server area networks (SANs) and multimedia multicast at a low cost for both local and wide-area networks.

Another important aspect of communication networks is security. While attacks on servers and the like have gained much notoriety recently, there are other security concerns relating to the transport of data itself. For example, “packet-sniffing” techniques in the like may be used to “steal” messages and/or data. While various techniques are currently being used to secure communication networks, none of these techniques have been applied to optical burst-switched networks due to the difference in how data is transmitted across optical burst-switched networks when compared with conventional communication networks.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a simplified block diagram illustrating a photonic burst-switched (PBS) network with variable time slot provisioning, according to one embodiment of the present invention;

FIG. 2 is a simplified flow diagram illustrating the operation of a photonic burst-switched (PBS) network, according to one embodiment of the present invention;

FIG. 3 is a block diagram illustrating a switching node module for use in a photonic burst-switched (PBS) network, according to one embodiment of the present invention;

FIG. 4 is a diagram illustrating PBS optical burst flow between nodes in a PBS network, according to one embodiment of the present invention;

FIG. 5 is a diagram illustrating generic PBS framing format for PBS optical bursts, according to one embodiment of the present invention;

FIG. 6 is a diagram illustrating further details of the PBS framing format of FIG. 5, according to one embodiment of the present invention.

FIG. 7 is a schematic diagram illustrating an integrated data and control-plane PBS software architecture with privacy management, according to one embodiment of the present invention;

FIG. 8a is a schematic diagram of a network infrastructure including a PBS network connected to multiple external networks;

FIG. 8b is a schematic diagram corresponding to the network infrastructure of FIG. 8a, wherein transmission routes in the PBS network are depicted as virtual lightpaths connecting a pair of edge nodes;

FIG. 8c is a schematic diagram corresponding to the network infrastructure of FIGS. 8a and 8b, showing further details of an exemplary set of virtual lightpaths connecting a pair of edge nodes, wherein a virtual lightpath comprises a concatenation of lightpath segments having the same or different wavelengths;

FIG. 9a is a schematic diagram corresponding to the PBS network portion of the diagrams of FIGS. 8a-c, further illustrating a first exemplary security key distribution scheme in which common keys are distributed to each PBS edge node, according to one embodiment of the present invention;

FIG. 9b is a schematic diagram corresponding to the PBS network portion of the diagrams of FIGS. 8a-c, further illustrating a second exemplary security key distribution scheme in which a particular set of keys is distributed to each PBS edge node, according to one embodiment of the present invention;

FIG. 9c is a schematic diagram corresponding to the PBS network portion of the diagrams of FIGS. 8a-c, further illustrating a third exemplary security key distribution scheme implemented with PKI techniques, according to one embodiment of the present invention;

FIG. 9d is a schematic diagram corresponding to the PBS network portion of the diagrams of FIGS. 8a-c, illustrating a fourth exemplary security key distribution scheme under with security keys and/or security data are generated at an edge node;

FIG. 10 is a diagram illustrating a data structure for an exemplary extended header format including fields in which security data may be provided, according to one embodiment of the present invention;

FIG. 11 is a flowchart illustrating setup and ongoing operations corresponding to a secure data transmission process under which existing keys are held by various PBS edge nodes, according to one embodiment of the present invention;

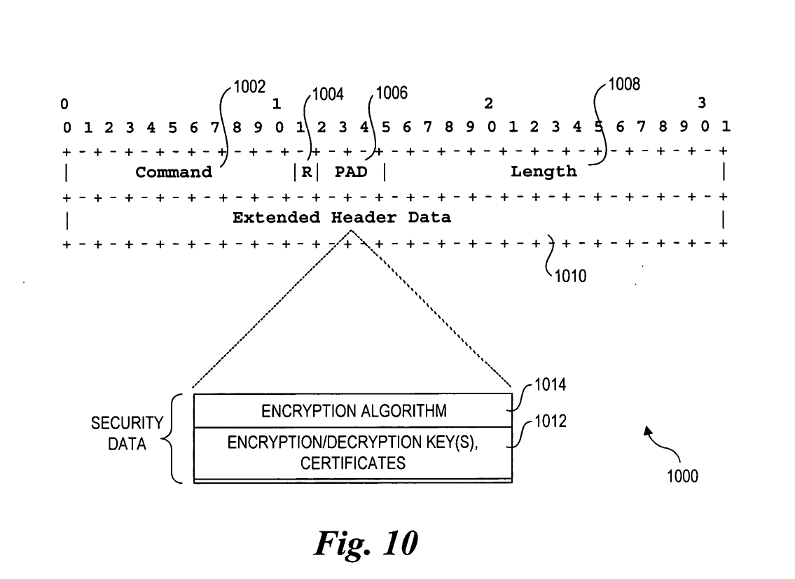

FIG. 10a is a block diagram illustrating an optical PBS I/O module, according to one embodiment of the present invention;

FIG. 10b is a block diagram illustrating in more detail the network processor unit and the queue unit depicted in FIG. 12a, according to one embodiment of the present invention;

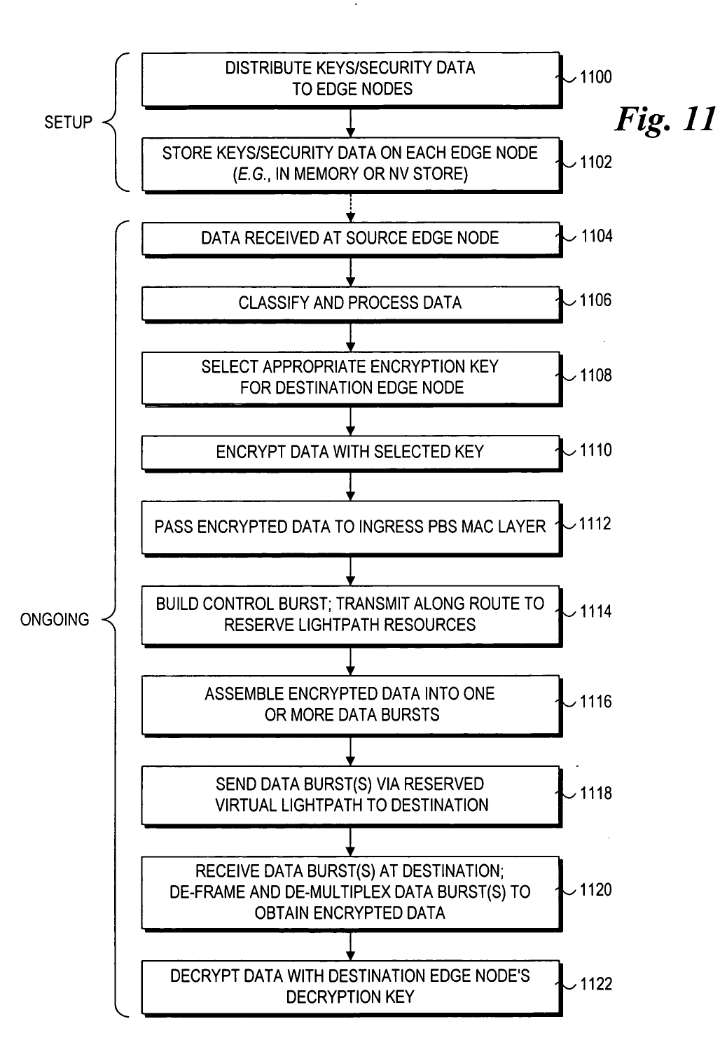

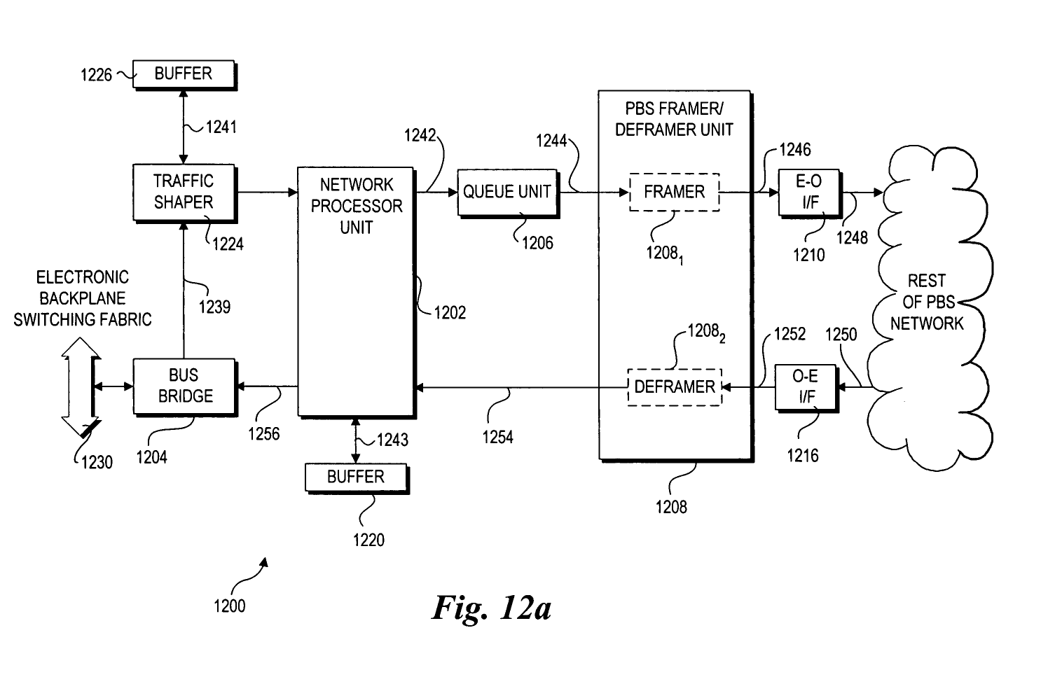

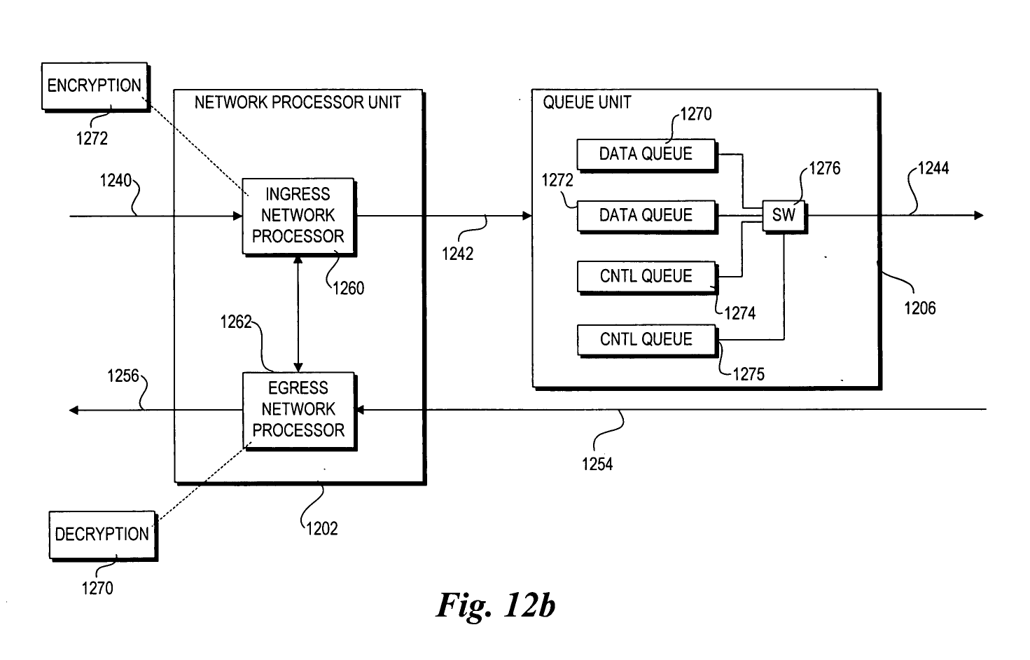

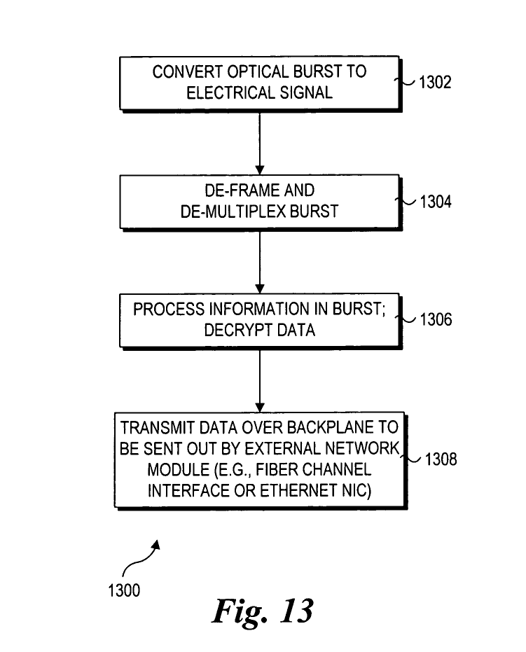

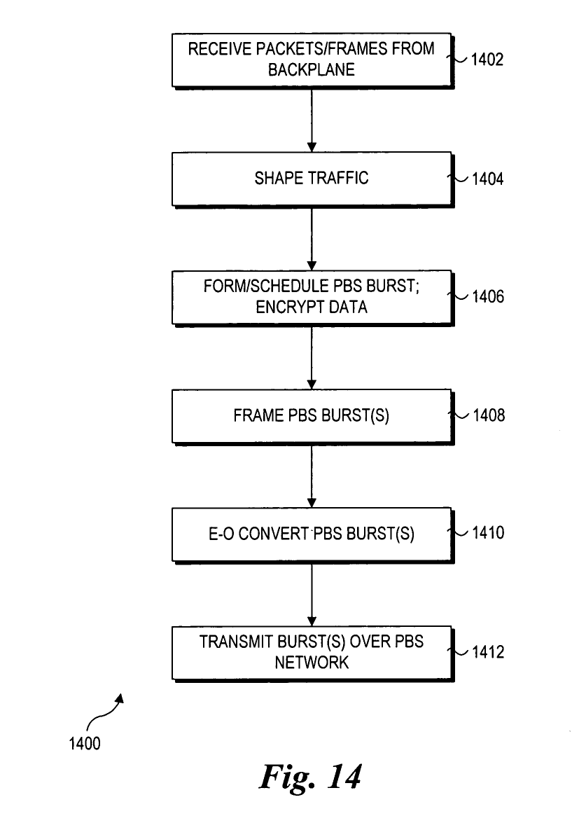

FIG. 11 is a flow diagram illustrating an operational flow to provide secure data transmission, according to one embodiment of the present invention;

FIG. 12a is a block diagram illustrating an optical PBS I/O module, according to one embodiment of the present invention;

FIG. 12b is a block diagram illustrating in more detail the network processor unit and the queue unit depicted in FIG. 14a, according to one embodiment of the present invention;

FIG. 13 is a flow diagram illustrating an egress operational flow, according to one embodiment of the present invention; and

FIG. 14 is a flow diagram illustrating an egress operational flow, according to one embodiment of the present invention.

### DETAILED DESCRIPTION OF PREFERRED EMBODIMENTS

Embodiments of techniques for secure transmission of data bursts within optical switched networks are described herein. In the following description, numerous specific details are set forth, such as descriptions of embodiments that are implemented for photonic burst-switched (PBS) networks, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the following detailed descriptions, embodiments of the invention are disclosed with reference to their use in photonic burst-switched (PBS) networks. A PBS network is a type of optical-switched network, typically comprising a high-speed hop and span-constrained network, such as an enterprise network. The term “photonic burst” is used herein to refer to statistically-multiplexed data flows (e.g., Internet protocol (IP) packets, Ethernet frames, Fibre Channel (FC) frames) having similar routing requirements. Although conceptually similar to backbone-based optical burst-switched (OBS) networks, the design, operating-constraints, and performance requirements of these high-speed hop and span-constrained networks may be different. However, it will be understood that the teaching and principles disclosed herein may be applicable to other types of optical switched networks as well.

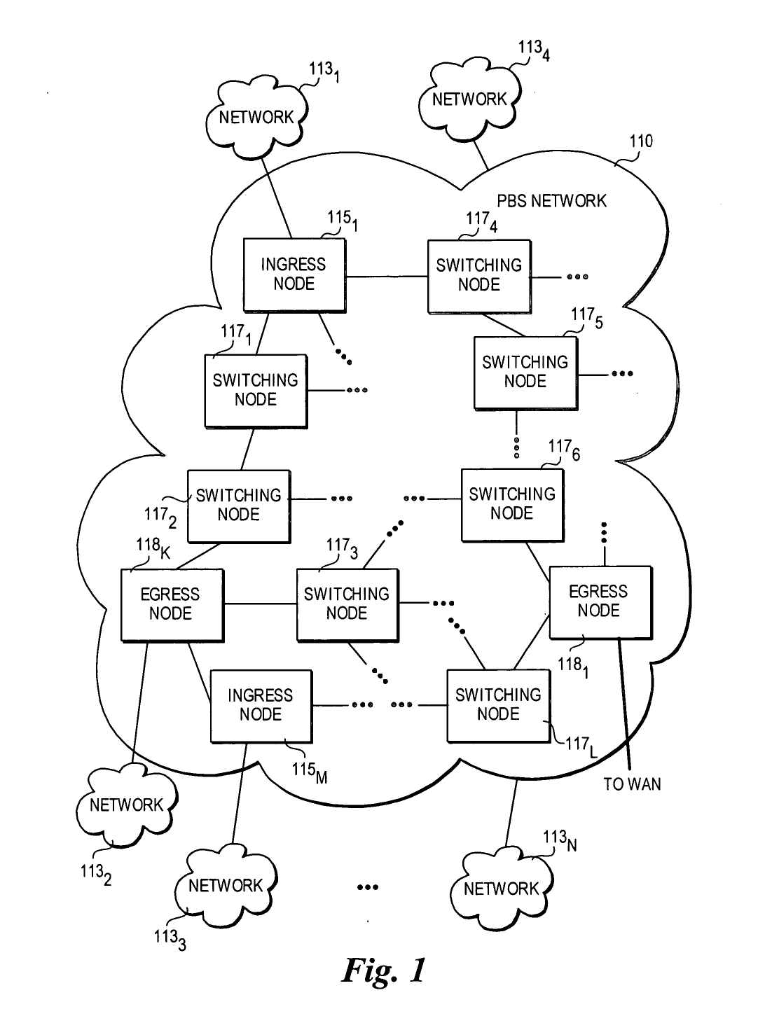

FIG. 1 illustrates an exemplary photonic burst-switched (PBS) network 110 in which embodiments of the invention described herein may be implemented. A PBS network is a type of optical switched network. This embodiment of PBS network 110 includes local area networks (LANs) 113₁-113_{N} and a backbone optical WAN (not shown). In addition, this embodiment of PBS network 110 includes ingress nodes 115₁-115_{M}, switching nodes 117₁-117_{L}, and egress nodes 118₁-118_{K}. PBS network 110 can include other ingress, egress and switching nodes (not shown) that are interconnected with the switching nodes shown in FIG. 1. The ingress and egress nodes are also referred to herein as edge nodes in that they logically reside at the edge of the PBS network. The edge nodes, in effect, provide an interface between the aforementioned “external” networks (i.e., external to the PBS network) and the switching nodes of the PBS network. In this embodiment, the ingress, egress and switching nodes are implemented with intelligent modules. This embodiment can be used, for example, as a metropolitan area network connecting a large number of LANs within the metropolitan area to a large optical backbone network.

In some embodiments, the ingress nodes perform optical-electrical (O-E) conversion of received optical signals, and include electronic memory to buffer the received signals until they are sent to the appropriate LAN/WAN. In addition, in some embodiments, the ingress nodes also perform electrical-optical (E-O) conversion of the received electrical signals before they are transmitted to switching nodes 117₁-117_{M} of PBS network 110.

Egress nodes are implemented with optical switching units or modules that are configured to receive optical signals from other nodes of PBS network 110 and route them to the optical WAN or other external networks. Egress nodes can also receive optical signals from the optical WAN or other external network and send them to the appropriate node of PBS network 110. In one embodiment, egress node 118₁ performs O-E-O conversion of received optical signals, and includes electronic memory to buffer received signals until they are sent to the appropriate node of PBS network 110 (or to the optical WAN).

Switching nodes 117₁-117_{L} are implemented with optical switching units or modules that are each configured to receive optical signals from other switching nodes and appropriately route the received optical signals to other switching nodes of PBS network 110. As is described below, the switching nodes perform O-E-O conversion of optical control bursts and network management control burst signals. In some embodiments, these optical control bursts and network management control bursts are propagated only on pre-selected wavelengths. The pre-selected wavelengths do not propagate optical “data” bursts (as opposed to control bursts and network management control bursts) signals in such embodiments, even though the control bursts and network management control bursts may include necessary information for a particular group of optical data burst signals. The control and data information is transmitted on separate wavelengths in some embodiments (also referred to herein as out-of-band (OOB) signaling). In other embodiments, control and data information may be sent on the same wavelengths (also referred to herein as in-band (IB) signaling). In another embodiment, optical control bursts, network management control bursts, and optical data burst signals may be propagated on the same wavelength(s) using different encoding schemes such as different modulation formats, etc. In either approach, the optical control bursts and network management control bursts are sent asynchronously relative to its corresponding optical data burst signals. In still another embodiment, the optical control bursts and other control signals are propagated at different transmission rates as the optical data signals.

Although switching nodes 117₁-117_{L} may perform O-E-O conversion of the optical control signals, in this embodiment, the switching nodes do not perform O-E-O conversion of the optical data burst signals. Rather, switching nodes 117₁-117_{L} perform purely optical switching of the optical data burst signals. Thus, the switching nodes can include electronic circuitry to store and process the incoming optical control bursts and network management control bursts that were converted to an electronic form and use this information to configure photonic burst switch settings, and to properly route the optical data burst signals corresponding to the optical control bursts. The new control bursts, which replace the previous control bursts based on the new routing information, are converted to an optical control signal, and it is transmitted to the next switching or egress nodes. Embodiments of the switching nodes are described further below.

Elements of exemplary PBS network 110 are interconnected as follows. LANs 113₁-113_{N} are connected to corresponding ones of ingress nodes 115₁-115_{M}. Within PBS network 110, ingress nodes 115₁-115_{M} and egress nodes 118¹-118^{K} are connected to some of switching nodes 117₁-117_{L} via optical fibers. Switching nodes 117₁-117_{L} are also interconnected to each other via optical fibers in mesh architecture to form a relatively large number of lightpaths or optical links between the ingress nodes, and between ingress nodes 115₁-115_{L} and egress nodes 118₁-118_{K}. Ideally, there are more than one lightpath to connect the switching nodes 117₁-117_{L} to each of the endpoints of PBS network 110 (i.e., the ingress nodes and egress nodes are endpoints within PBS network 110). Multiple lightpaths between switching nodes, ingress nodes, and egress nodes enable protection switching when one or more node fails, or can enable features such as primary and secondary route to destination.

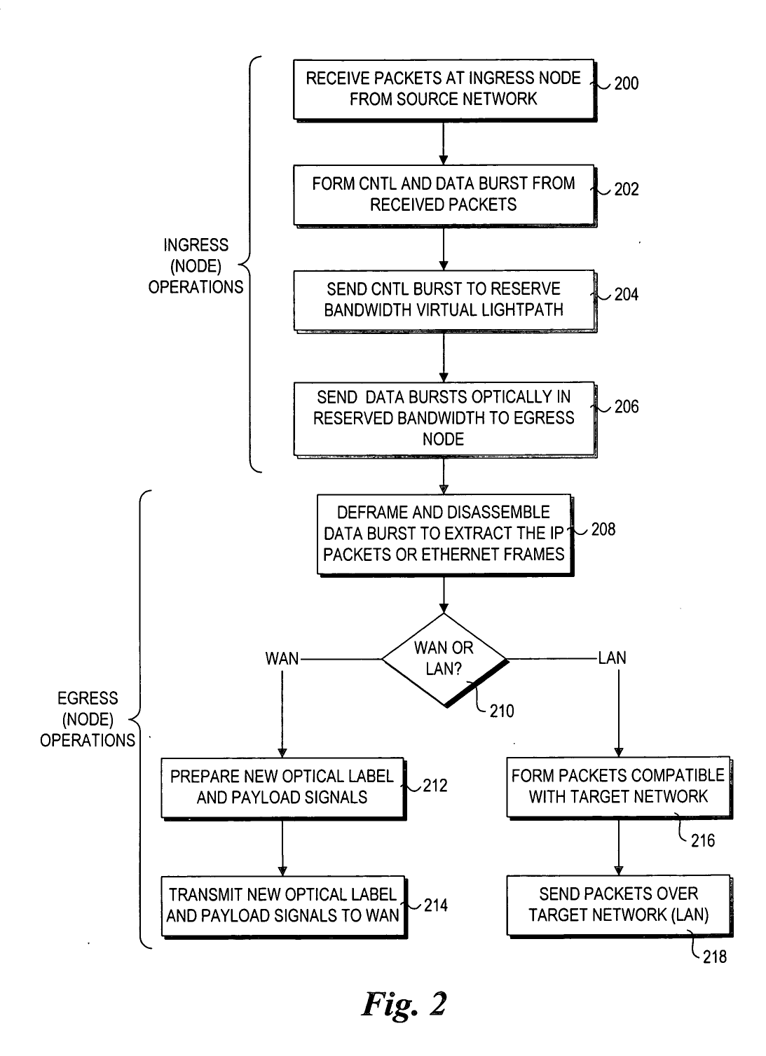

As described below in conjunction with FIG. 2, the ingress, egress and switching nodes of PBS network 110 are configured to send and/or receive optical control bursts, optical data burst, and other control signals that are wavelength multiplexed so as to propagate the optical control bursts and control labels on pre-selected wavelength(s) and optical data burst or payloads on different pre-selected wavelength(s). Still further, the edge nodes of PBS network 110 can send optical control burst signals while sending data out of PBS network 110 (either optical or electrical).

FIG. 2 illustrates the operational flow of PBS network 110, according to one embodiment of the present invention. Referring to FIGS. 1 and 2, photonic burst switching network 110 operates as follows.

The process begins in a block 200, wherein PBS network 110 receives packets from LANs 113₁-113_{N}. In one embodiment, PBS network 110 receives IP packets at ingress nodes 115₁-115_{M}. The received packets can be in electronic form rather than in optical form, or received in optical form and then converted to electronic form. In this embodiment, the ingress nodes store the received packets electronically.

For clarity, the rest of the description of the operational flow of PBS network 110 focuses on the transport of information from ingress node 115₁ to egress node 118₁. The transport of information from ingress nodes 115₂-115_{M} to egress node 118₁ (or other egress nodes) is substantially similar.

An optical burst label (i.e., an optical control burst) and optical payload (i.e., an optical data burst) is formed from the received packets, as depicted by a block 202. In one embodiment, ingress node 115₁ uses statistical multiplexing techniques to form the optical data burst from the received IP (Internet Protocol) packets stored in ingress node 115₁. For example, packets received by ingress node 115₁ and having to pass through egress node 118₁ on their paths to a destination can be assembled into an optical data burst payload.

Next, in a block 204, bandwidth on a specific optical channel and/or fiber is reserved to transport the optical data burst through PBS network 110. In one embodiment, ingress node 115₁ reserves a time slot (i.e., a time slot of a TDM system) in an optical data signal path through PBS network 110 using a control burst. This time slot maybe fixed-time duration and/or variable-time duration with either uniform or non-uniform timing gaps between adjacent time slots. Further, in one embodiment, the bandwidth is reserved for a time period sufficient to transport the optical burst from the ingress node to the egress node. For example, in some embodiments, the ingress, egress, and switching nodes maintain an updated list of all used and available time slots. The time slots can be allocated and distributed over multiple wavelengths and optical fibers. Thus, a reserved time slot (also referred to herein as a TDM channel), which in different embodiments may be of fixed-duration or variable-duration, may be in one wavelength of one fiber, and/or can be spread across multiple wavelengths and multiple optical fibers.

In one embodiment, when an ingress and/or egress node reserves bandwidth using a control burst or when bandwidth is released after an optical data burst is transported, a network controller (not shown) updates the list. In one embodiment, the network controller and the ingress or egress nodes perform this updating process using various burst or packet scheduling algorithms based on the available network resources and traffic patterns. Generally, the network controller function can reside in one of the ingress or egress nodes, or can be distributed across two or more ingress and/or egress nodes.

The optical data bursts are then transported through photonic burst switching network 110 in the reserved time slot or TDM channel, as depicted by a block 206. In one embodiment, ingress node 115₁ transmits the control burst to the next node along the optical label-switched path (OLSP) determined by the network controller. In this embodiment, the network controller uses a constraint-based routing protocol [e.g., multi-protocol label switching (MPLS)] over one or more wavelengths to determine the best available OLSP to the egress node.

In one embodiment, the control label (also referred to herein as a control burst) is transmitted asynchronously ahead of the photonic data burst and on a different wavelength and/or different fiber. The time offset between the control burst and the data burst allows each of the switching nodes to process the label and configure the photonic burst switches to appropriately switch before the arrival of the corresponding data burst. The term photonic burst switch is used herein to refer to fast optical switches that do not use O-E-O conversion.

In one embodiment, ingress node 115₁ then asynchronously transmits the optical data bursts to the switching nodes where the optical data bursts experience little or no time delay and no O-E-O conversion within each of the switching nodes. The optical control burst is always sent before the corresponding optical data burst is transmitted.

In some embodiments, the switching node may perform O-E-O conversion of the control bursts so that the node can extract and process the routing information contained in the label. Further, in some embodiments, the TDM channel is propagated in the same wavelengths that are used for propagating labels. Alternatively, the labels and payloads can be modulated on the same wavelength in the same optical fiber using different modulation formats. For example, optical labels can be transmitted using non-return-to-zero (NRZ) modulation format, while optical payloads are transmitted using return-to-zero (RZ) modulation format on the same wavelength. The optical burst is transmitted from one switching node to another switching node in a similar manner until the optical control and data bursts are terminated at egress node 118₁.

The remaining set of operations pertains to egress node operations. Upon receiving the data burst, the egress node de-frames and disassembles it to extract the IP packets or Ethernet frames in a block 208. In one embodiment, egress node 118, converts the optical data burst to electronic signals that egress node 118, can process to recover the data segment of each of the packets. The operational flow at this point depends on whether the target network is an optical WAN or a LAN, as depicted by a decision block 210.

If the target network is an optical WAN, new optical label and payload signals are formed in a block 212. In this embodiment, egress node 118₁ prepares the new optical label and payload signals. The new optical label and payload are then transmitted to the target network (i.e., WAN in this case) in a block 214. In this embodiment, egress node 118₁ includes an optical interface to transmit the optical label and payload to the optical WAN.

However, if in decision block 210 the target network is determined to be a LAN, the logic proceeds to a block 216. Accordingly, the extracted IP data packets or Ethernet frames are processed, combined with the corresponding IP labels, and then routed to the target network (i.e., LAN in this case). In this embodiment, egress node 118₁ forms these new IP packets. The new IP packets are then transmitted to the target network (i.e., LAN) as shown in block 210.

PBS network 110 can achieve increased bandwidth efficiency through the additional flexibility afforded by the TDM channels. Although this exemplary embodiment described above includes an optical MAN having ingress, switching and egress nodes to couple multiple LANs to an optical WAN backbone, in other embodiments the networks do not have to be LANs, optical MANs or WAN backbones. That is, PBS network 110 may include a number of relatively small networks that are coupled to a relatively larger network that in turn is coupled to a backbone network.

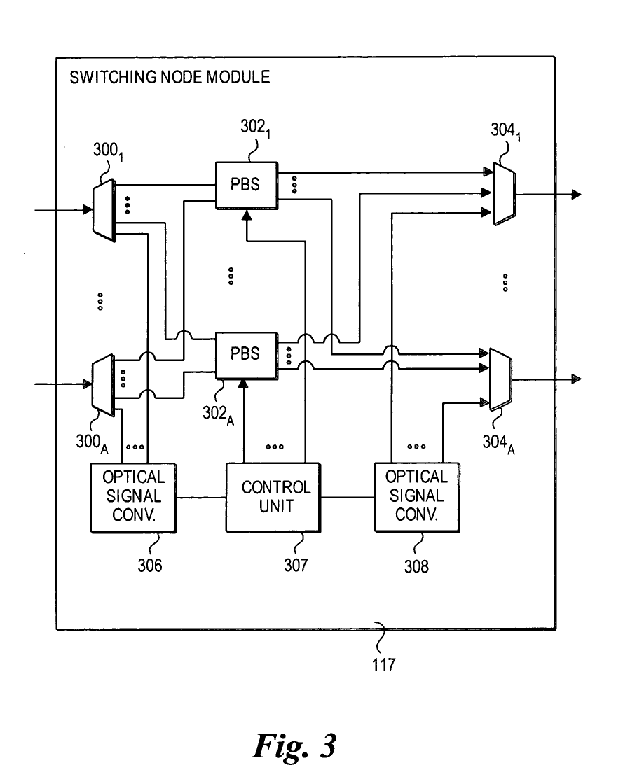

FIG. 3 illustrates a module 117 for use as a switching node in photonic burst switching network 110 (FIG. 1), according to one embodiment of the present invention. In this embodiment, module 117 includes a set of optical wavelength division demultiplexers 300₁-300_{A}, where A represents the number of input optical fibers used for propagating payloads, labels, and other network resources to the module. For example, in this embodiment, each input fiber could carry a set of C wavelengths (i.e., WDM wavelengths), although in other embodiments the input optical fibers may carry differing numbers of wavelengths. Module 117 would also include a set of N×N photonic burst switches 302₁-302_{B}, where N is the number of input/output ports of each photonic burst switch. Thus, in this embodiment, the maximum number of wavelengths at each photonic burst switch is A·C, where N≧A—C+1. For embodiments in which N is greater than A·C, the extra input/output ports can be used to loop back an optical signal for buffering.

Further, although photonic burst switches 302₁-302_{B} are shown as separate units, they can be implemented as N×N photonic burst switches using any suitable switch architecture. Module 117 also includes a set of optical wavelength division multiplexers 304₁-304_{A}, a set of optical-to-electrical signal converters 306 (e.g., photo-detectors), a control unit 307, and a set of electrical-to-optical signal converters 308 (e.g., lasers). Control unit 307 may have one or more processors to execute software or firmware programs.

The elements of this embodiment of module 117 are interconnected as follows. Optical demultiplexers 300₁-300_{A} are connected to a set of A input optical fibers that propagate input optical signals from other switching nodes of photonic burst switching network 110. The output leads of the optical demultiplexers are connected to the set of B core optical switches 302₁-302_{B} and to optical signal converter 306. For example, optical demultiplexer 300, has B output leads connected to input leads of the photonic burst switches 302₁-302_{B} (i.e., one output lead of optical demultiplexer 300₁ to one input lead of each photonic burst switch) and at least one output lead connected to optical signal converter 306.

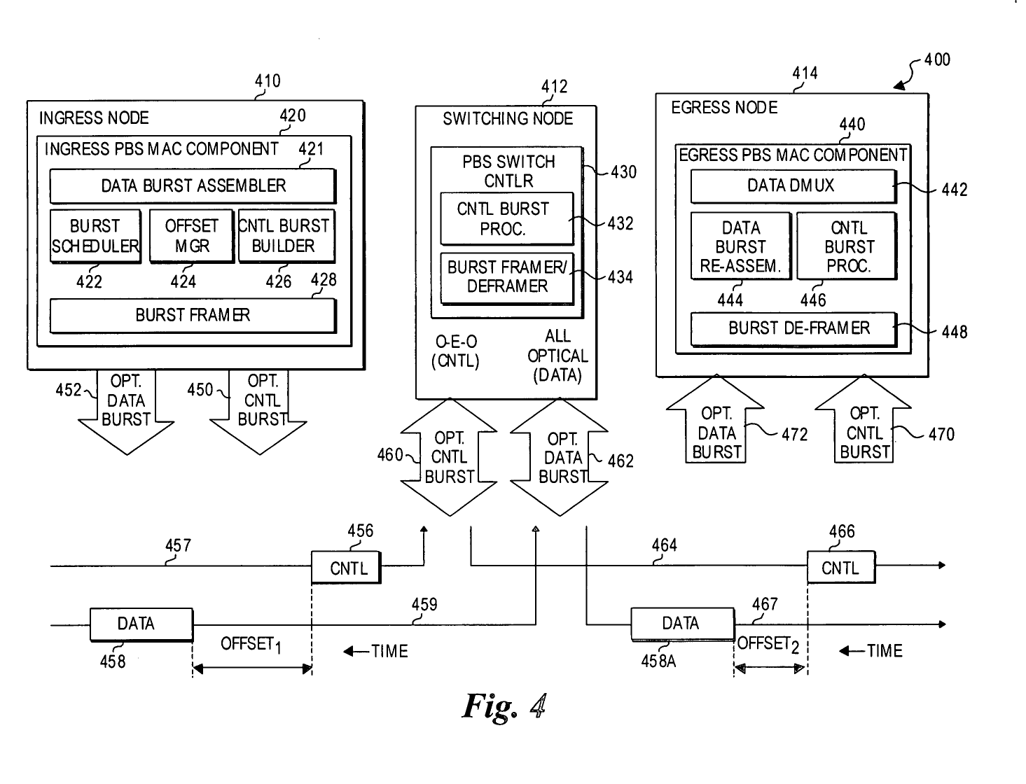

The output leads of photonic burst switches 302₁-302_{B} are connected to optical multiplexers 304₁-304_{A}. For example, photonic burst switch 302₁ has A output leads connected to input leads of optical multiplexers 304₁-304_{A} (i.e., one output lead of photonic burst switch 302₁ to one input lead of each optical multiplexer). Each optical multiplexer also an input lead connected to an output lead of electrical-to-optical signal converter 308. Control unit 307 has an input lead or port connected to the output lead or port of optical-to-electrical signal converter 306. The output leads of control unit 307 are connected to the control leads of photonic burst switches 302₁-302_{B} and electrical-to-optical signal converter 308. As described below in conjunction with the flow diagram of FIG. 4, module 117 is used to receive and transmit optical control bursts, optical data bursts, and network management control bursts.

FIG. 4 illustrates PBS optical burst flow between nodes under an exemplary PBS architecture 400, according to one embodiment of the present invention. Architecture 400 includes an ingress node 410, a switching node 412, an egress node 414 and other nodes (egress, switching, and ingress that are not shown to avoid obscuring the description of the optical burst flow). In this embodiment, the illustrated components of ingress, switching and egress nodes 410, 412 and 414 are implemented using machine-readable instructions that cause a machine (e.g., a processor) to perform operations that allow the nodes to transfer information to and from other nodes in the PBS network. In this example, the lightpath for the optical burst flow is from ingress node 410, to switching node 412 and then to egress node 414.

Ingress node 410 includes an ingress PBS MAC (Media Access Channel) layer component 420 having a data burst assembler 421, a data burst scheduler 422, an offset time manager 424, a control burst builder 426 and a burst framer 428. In one embodiment, data burst assembler 421 assembles the data bursts to be optically transmitted over PBS network 110. In one embodiment, the size of the data burst is determined based on many different network parameters such as quality-of-service (QoS), number of available optical channels, the size of electronic buffering at the ingress nodes, the specific burst assembly algorithm, etc.

Data burst scheduler 422, schedules the data burst transmission over PBS network 110. Ingress PBS MAC layer component 410 generates a bandwidth request for insertion into the control burst associated with the data burst being formed. In one embodiment, data burst scheduler 422 also generates the schedule to include an offset time (from offset manager 424 described below) to allow for the various nodes in PBS network 110 to process the control burst before the associated data burst arrives.

In one embodiment, offset time manager 424 determines the offset time based on various network parameters such as, for example, the number of hops along the selected lightpath, the processing delay at each switching node, traffic loads for specific lightpaths, and class of service requirements. Then control burst builder 426 builds the control burst using information such as the required bandwidth, burst scheduling time, in-band or out-of-band signaling, burst destination address, data burst length, data burst channel wavelength, offset time, priorities, and the like.

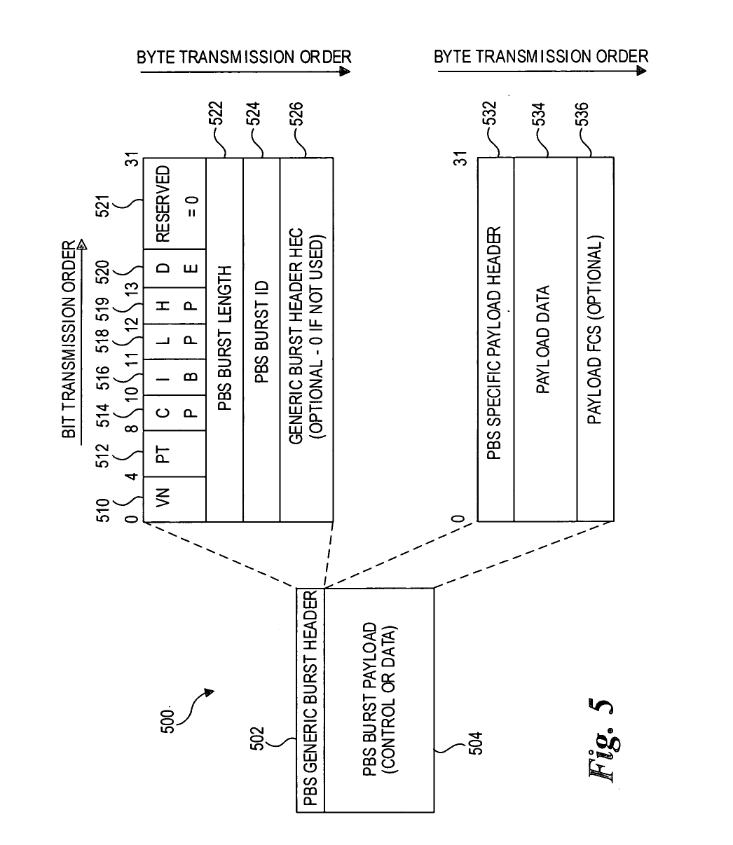

Burst framer 428 frames the control and data bursts (using the framing format described below in conjunction with FIGS. 5, 6, and 10 in some embodiments). Burst framer 428 then transmits the control burst over PBS network 110 via a physical optical interface (not shown), as indicated by an arrow 450. In one embodiment, the control burst is transmitted out of band (OOB) to switching node 412, as indicated by an optical control burst 456 and PBS TDM channel 457 in FIG. 4. Burst framer 428 then transmits the data burst according to the schedule generated by burst scheduler 422 to switching node 412 over the PBS network via the physical optical interface, as indicated by an optical burst 458 and PBS TDM channel 459 in FIG. 4. The time delay between optical bursts 456 (control burst) and 458 (data burst) in indicated as an OFFSET₁ in FIG. 4.

Switching node 412 includes a PBS switch controller 430 that has a control burst processing component 432, a burst framer/de-framer 434 and a hardware PBS switch (not shown). Optical control burst 456 is received via a physical optical interface (not shown) and optical switch (not shown) and converted to electrical signals (i.e., O-E conversion). Control burst framer/de-framer 434 de-frames the control burst information and provides the control information to control burst processing component 432. Control burst processing component 432 processes the information, determining the corresponding data burst's destination, bandwidth reservation, next control hop, control label swapping etc.

PBS switch controller component 430 uses some of this information to control and configure the optical switch (not shown) to switch the optical data burst at the appropriate time duration to the next node (i.e., egress node 414 in this example) at the proper channel. In some embodiments, if the reserved bandwidth is not available, PBS switch controller component 430 can take appropriate action. For example, in one embodiment PBS switch controller 430 can: (a) determine a different lightpath to avoid the unavailable optical channel (e.g., deflection routing); (b) delay the data bursts using integrated buffering elements within the PBS switch fabric such as fiber delay lines; (c) use a different optical channel (e.g. by using tunable wavelength converters); and/or (d) drop only the coetaneous data bursts. Some embodiments of PBS switch controller component 430 may also send a negative acknowledgment message back to ingress node 410 to re-transmit the dropped burst.

However, if the bandwidth can be found and reserved for the data burst, PBS switch controller component 430 provides appropriate control of the hardware PBS switch (not shown). In addition, PBS switch controller component 430 generates a new control burst based on the updated reserved bandwidth from control burst processing component 432 and the available PBS network resources. Control burst framer/de-framer 434 then frames the re-built control burst, which is then optically transmitted to egress node 414 via the physical optical interface (not shown) and the optical switch (not shown), as indicated by PBS TDM channel 464 and an optical control burst 466 in FIG. 4.

Subsequently, when the optical data burst corresponding to the received/processed control burst is received by switching node 412, the hardware PBS switch is already configured to switch the optical data burst to egress node 414. In other situations, switching node 412 can switch the optical data burst to a different node (e.g., another switching node not shown in FIG. 4). The optical data burst from ingress node 410 is then switched to egress node 414, as indicated by PBS TDM channel 467 and an optical data burst 458A. In this embodiment, optical data burst 458A is simply optical data burst 458 re-routed by the hardware PBS switch (not shown), but possibly transmitted in a different TDM channel. The time delay between optical control burst 466 and optical data burst 458A is indicated by an OFFSET₂ in FIG. 4, which is smaller than OFFSET₁ due, for example, to processing delay and other timing errors in switching node 412.

Egress node 414 includes a PBS MAC component 440 that has a data demultiplexer 442, a data burst re-assembler 444, a control burst processing component 446, and a data burst de-framer 448. Egress node 414 receives the optical control burst as indicated by an arrow 470 in FIG. 4. Burst de-framer 448 receives and de-frames the control burst via a physical O-E interface (not shown). In this embodiment, control burst processing component 446 processes the de-framed control burst to extract the pertinent control/address information.

After the control burst is received, egress node 414 receives the data burst(s) corresponding to the received control burst, as indicated by an arrow 472 in FIG. 4. In this example, egress node 414 receives the optical data burst after a delay of OFFSET₂, relative to the end of the control burst. In a manner similar to that described above for received control bursts, burst de-framer 448 receives and de-frames the data burst. Data burst re-assembler 444 then processes the de-framed data burst to extract the data (and to re-assemble the data if the data burst was a fragmented data burst). Data de-multiplexer 442 then appropriately de-multiplexes the extracted data for transmission to the appropriate destination (which can be a network other than the PBS network).

FIG. 5 illustrates a generic PBS framing format 500 for PBS optical bursts, according to one embodiment of the present invention. Generic PBS frame 500 includes a PBS generic burst header 502 and a PBS burst payload 504 (which can be either a control burst or a data burst). FIG. 5 also includes an expanded view of PBS generic burst header 502 and PBS burst payload 504.

PBS generic burst header 502 is common for all types of PBS bursts and includes a version number (VN) field 510, a payload type (PT) field 512, a control priority (CP) field 514, an in-band signaling (IB) field 516, a label present (LP) field 518, a header error correction (HEC) present (HP) field 519, a data encryption (DE) field 520, a burst length field 522, and a burst ID field 524. In some embodiments, PBS generic burst header also includes a reserved field 521 and a HEC field 526. Specific field sizes and definitions are described below for framing format having 32-bit words; however, in other embodiments, the sizes, order and definitions can be different.

In this embodiment, PBS generic burst header 502 is a 4-word header. The first header word includes VN field 510, PT field 512, CP field 514, IB field 516 and LP field 518. VN field 510 in this exemplary embodiment is a 4-bit field (e.g., bits 0-3) defining the version number of the PBS Framing format being used to frame the PBS burst. In this embodiment, VN field 510 is defined as the first 4-bits of the first word, but in other embodiments, it need not be limited to the 4-bits, or be in the first word.

PT field 512 is a 4-bit field (bits 4-7) that defines the payload type. Exemplary payload types are shown below.

CP field 514 is a 2-bit field (bits 8-9) that defines the burst's priority. For example, binary “00” may indicate a normal priority while binary “01” indicates a high priority.

IB field 516 is a one-bit field (bit 8) that indicates whether the PBS control burst is being signaled in-band or OOB. For example, binary “0” may indicate OOB signaling while binary “1” indicates in-band signaling. LP field 518 is a one-bit field (bit 11) used to indicate whether a label has been established for the lightpath carrying this header.

HP field 519 is a one-bit field (bit 12) used to indicate whether header error correction is being used in this control burst. For example, binary “1” may indicate header error correction is used, while binary “0” indicates it is not used.

Data Encryption (DE) field 520 is a one-bit field (bit 13) used to indicate whether subsequent data bursts (corresponding to a control burst for which DE field 520 is asserted) contains encrypted data. The remaining bits (bits 14-31) form reserved field 521, which is currently unused and reserved for future use.

The second word in PBS generic burst header 502 contains PBS burst length field 522, which is used to store a binary value equal to the length the number of bytes in PBS burst payload 504. In this embodiment, the PBS burst length field is 32-bits.

The third word in PBS generic burst header 502 contains PBS burst IUD field 524, which is used to store an identification number for this burst. In this embodiment, PBS burst ID field 524 is 32-bits generated by the ingress node (e.g., ingress node 410 in FIG. 4).

The fourth word in PBS generic burst header 502 contains generic burst header HEC field 526, which is used to store an error correction word. In this embodiment, generic burst header HEC field 526 is 32-bits generated using any suitable known error correction technique. As in indicated in FIG. 5, generic burst header HEC field 526 is optional in that if error correction is not used, the field may be filled with all zeros. In other embodiments, generic burst header HEC field 526 is not included in PBS generic burst header 502.

PBS burst payload 504 is common for all types of PBS bursts and includes a PBS specific payload header field 532, a payload field 534, and a payload frame check sequence (FCS) field 536.

In this exemplary embodiment, PBS specific payload header 532 is the first part (i.e., one or more words) of PBS burst payload 504. Typically, specific payload header field 532 includes one or more fields for information related to a data burst, which can be either this burst itself or contained in another burst associated with this burst (i.e., when this burst is a control burst).

Payload data field 534 is the next portion of PBS burst payload 504. In some embodiments, control bursts have no payload data, so this field may be omitted or contain all zeros. For data bursts, payload data field 534 may be relatively large (e.g., containing multiple data packets or frames).

Payload FCS field 536 is the next portion of PBS burst payload. In this embodiment, payload FCS field 536 is a one-word field (i.e., 32-bits) used in error detection and/or correction. As in indicated in FIG. 5, payload FCS field 536 is optional in that if error detection/correction is not used, the field may be filled with all zeros. In other embodiments, payload FCS field 536 is not included in PBS burst payload 504.

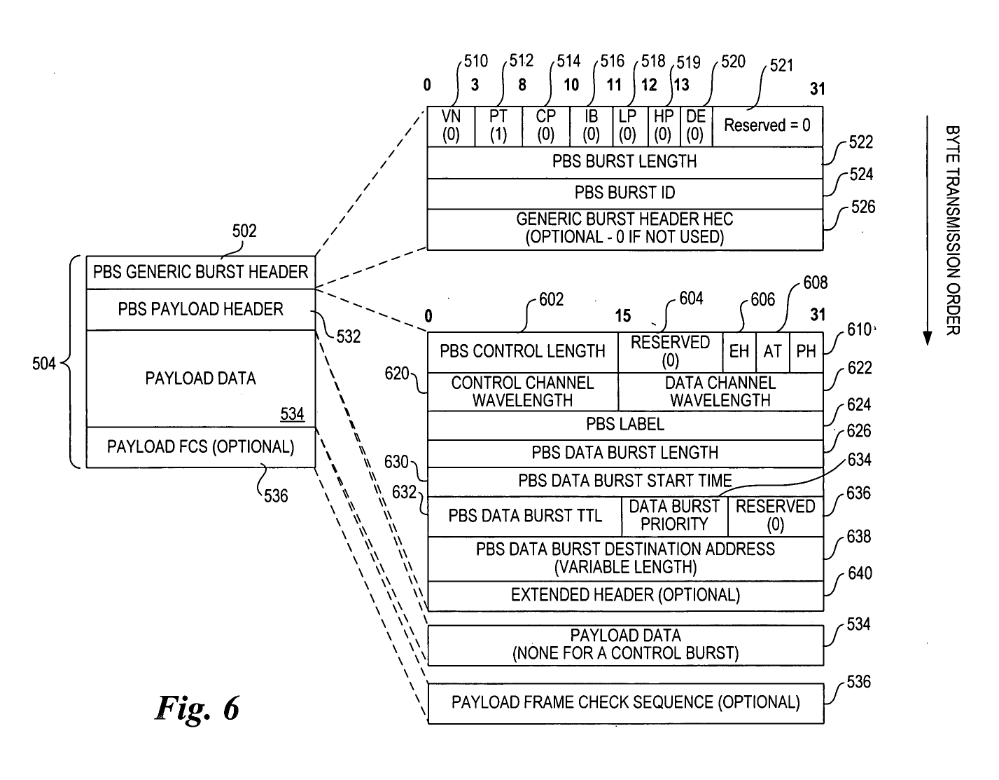

FIG. 6 illustrates a PBS optical control burst framing format 600, according to one embodiment of the present invention. To help improve clarity, FIG. 6 includes the expanded views of PBS generic burst header 502 and PBS burst payload 504 (previously described in conjunction with FIG. 5), with a further expansion of PBS payload header field 532 (described below) when part of a control burst. In this example, the PT field is set to “01” to indicate that the burst is a control burst. The CP field is set to “0” to indicate that the burst has normal priority. The IB field is set to “0” to indicate that the burst is using OOB signaling. The LP field is set to “0” to indicate that there is no label for this control burst.

In this exemplary embodiment of a PBS control burst, PBS payload header field 532 includes: a PBS control length field 602; an extended header (EH) field 606; an address type (AT) field 608; a payload FCS present (PH) field 610; a control channel wavelength field 620; a data channel wavelength field 622; a PBS label field 624; a PBS data burst length field 626; a PBS data burst start time field 630; a PBS data burst time-to-live (TTL) field 632; a data burst priority field 634; a PBS data burst destination address field 638; and an optional extended header field 640.

In this embodiment, the first word of PBS payload header 532 includes PBS control length field 602, which is used for storing the length of the control header in bytes. In this embodiment, PBS control length field 602 is a 16-bit field (bits 0-15) calculated by control burst builder 426 or control burst processor 432 (FIG. 4). In other embodiments, PBS control length field 602 need not be the first 16-bits, in the first word, or limited to 16-bits. A reserved field 604 (bits 16-27) is included in PBS payload header 532 in this embodiment. In other embodiments, these bits may be used for other field(s).

The first word of PBS payload header 532 also includes EH field 606, which is used in this embodiment to indicate whether an extended header is present in the burst. In this embodiment, EH field 606 is a 1-bit field (bit 28). In other embodiments, EH field 606 need not be bit 28, or in the first word.

The first word of PBS payload header 532 also includes AT field 608, which is used in this embodiment to indicate the address type of the associated PBS data burst's destination. For example, the address type may be an IP address (e.g., IPv4, IPv6), a network service access point (NSAP) address, an Ethernet address or other type of address. In one embodiment, AT field 608 is a 2-bit field (bits 29-30).

The first word of PBS payload header 532 also includes PH field 610, which is used to indicate whether a payload FCS is present in the burst. In this embodiment, PH field 610 is a 1-bit field (bit 31).

The second word of PBS payload header 532 includes control channel wavelength field 620, which is used to indicate a WDM wavelength in which the control burst is supposed to be modulated. In this embodiment, control channel wavelength field 620 is a 16-bit field (bits 0-15).

The second word of PBS payload header 532 also includes data channel wavelength field 622, which is used to indicate a WDM wavelength in which the data burst is to be modulated. In this embodiment, data channel wavelength field 622 is a 16-bit field (bits 16-31).

A third word of PBS payload header 532 includes PBS label field 624, which is used to store the label (if any) for the lightpath being used by the burst. In this embodiment, the label is a 32-bit word generated by a label management component.

A fourth word of PBS payload header 532 includes PBS data burst length field 626. In this embodiment, the PBS data burst length is a 32-bit word.

A fifth word of PBS payload header 532 includes PBS data burst start time field 630. In this embodiment, the PBS data burst start time is a 32-bit word, generated by burst scheduler 422 (FIG. 4).

A sixth word of PBS payload header 532 includes PBS data TTL field 632. In this embodiment, PBS data TTL field 632 is a 16-bit (bits 0-15) field, generated by ingress PBS MAC component 420 (FIG. 4). For example, in one embodiment, burst scheduler 422 (FIG. 4) of ingress PBS MAC component 420 can generate the TTL value.

The sixth word of PBS payload header 532 also includes data burst priority field 632. In this embodiment, data burst priority field 632 is an 8-bit field (bits 14-23), generated by ingress PBS MAC component 420 (FIG. 4). For example, in one embodiment, burst scheduler 422 (FIG. 4) of ingress PBS MAC component 420 can generate the data burst priority value. Further, in this embodiment, the sixth word of PBS payload header 532 includes a reserved field 636 (bits 24-31) which can be used in the future for other field(s).

A seventh word of PBS payload header 532 also includes PBS data burst destination address field 638. In this embodiment, PBS data burst destination address field 638 is variable length field, shown as a single 32-bit word for clarity. The actual length of the address may vary, depending on the address type as indicated in AT field 608.

An eight word of PBS payload header 532 can include an optional extended header field 640. This header can be used to hold other header data that may be used in the future. When this header is used, EH field 606 is set to 1. In this embodiment, payload data field 534 and payload FCS field 536 have been described above.

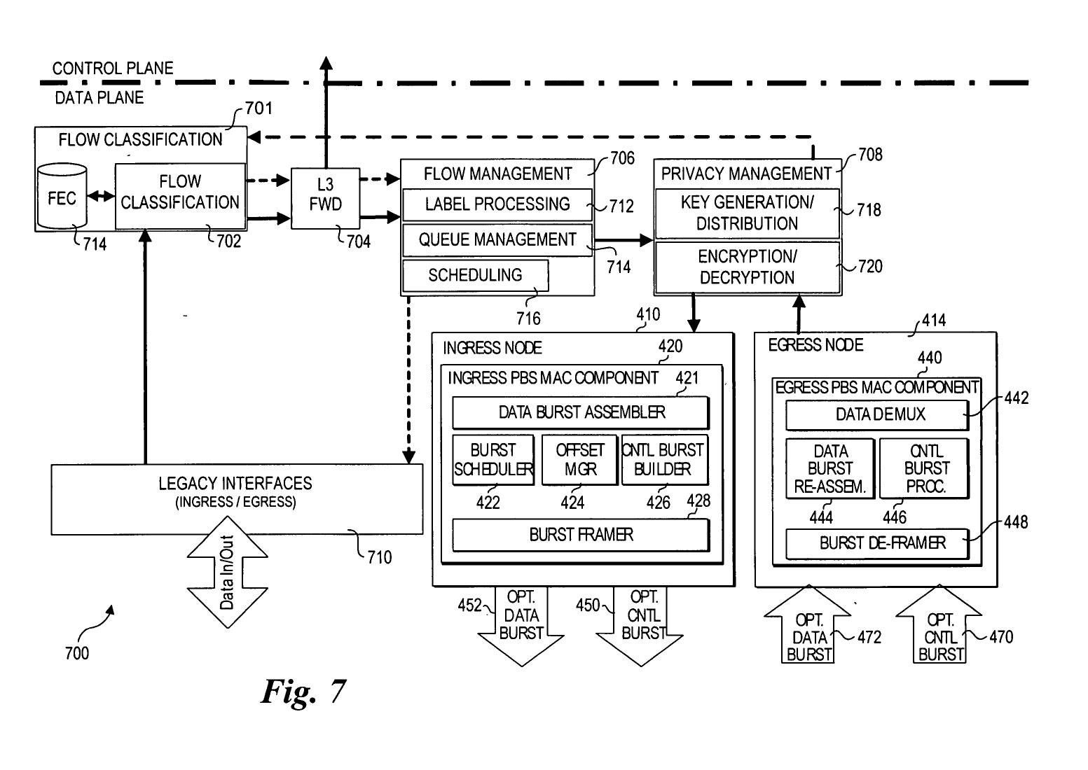

FIG. 7 shows an integrated data and control-plane PBS software architecture 700 with the key building blocks at ingress/egress nodes. Data plane components in architecture 700 includes a flow classification building block 701 including a flow classification block 702, an L3 (Layer 3, i.e. the Internet layer in the networking stack) forwarding block 704, a flow management building block 706, a privacy management building block 708, and legacy interfaces 710. The flow management building block 706 includes a label processing block 712, a queue management block 714, and a scheduling block 716. The privacy management building block 708 includes a key generation/distribution block 718, and an encryption/decryption block 720. In general, all or a portion of the key generation/distribution block 718, and an encryption/decryption block 720 may be embodied as one or more software modules, or may comprises hardware components that are programmed to perform corresponding operations. In addition, the data plane components include the ingress node 410 and egress node 414 components discussed above with reference to FIG. 4.

On the data path, packets from legacy interfaces 710, (i.e., IP packets or Ethernet frames) are classified by flow classification block 702 based on n-tuples classification into forward-equivalent classes (FECs) 722 at the ingress/egress node. Specifically, an PBS MAC layer at the ingress node typically performs data burst assembly and scheduling, control burst generation, and PBS logical framing, while de-framing, de-fragmentation and flow de-multiplexing are performed at the egress node. Once classified, data corresponding to a given FEC is forwarded to L3 forward block 704. If the flow is for this node IP address, i.e. this node L3 address, then the flow is given to this node for processing, i.e., it is given to this node control plane to be processed.

The next operations concern flow management. These are handled by label processing block 712 and queue management block 714. Timing of when portions of data destined for legacy network components are sent is determined by scheduling block 716.

In accordance with further aspects of the invention, techniques for securing transmitting data burst across PBS networks are now discussed. In general, after data received at an ingress node are classified and processed, they are encrypted within privacy management building block 708. The encryption decision may be based on user choice and/or management station policies. The data are then encrypted and forwarded to ingress PBS MAC component 420, where they are assembled into appropriate data burst that are scheduled for dispatch. Upon dispatch, the encrypted data based on the selected encryption method as described below (i.e., PKI) are sent to a destined egress node defined by a virtual lightpath comprising one or more hops. In response to receiving data burst, the egress node de-frames the burst and re-assembles the data. The data are then passed to a privacy management block 708 hosted by the egress node, whereupon the re-assembled data are decrypted. The data may then be sent in its decrypted form to an external (to the PBS network) network via legacy interfaces 710.

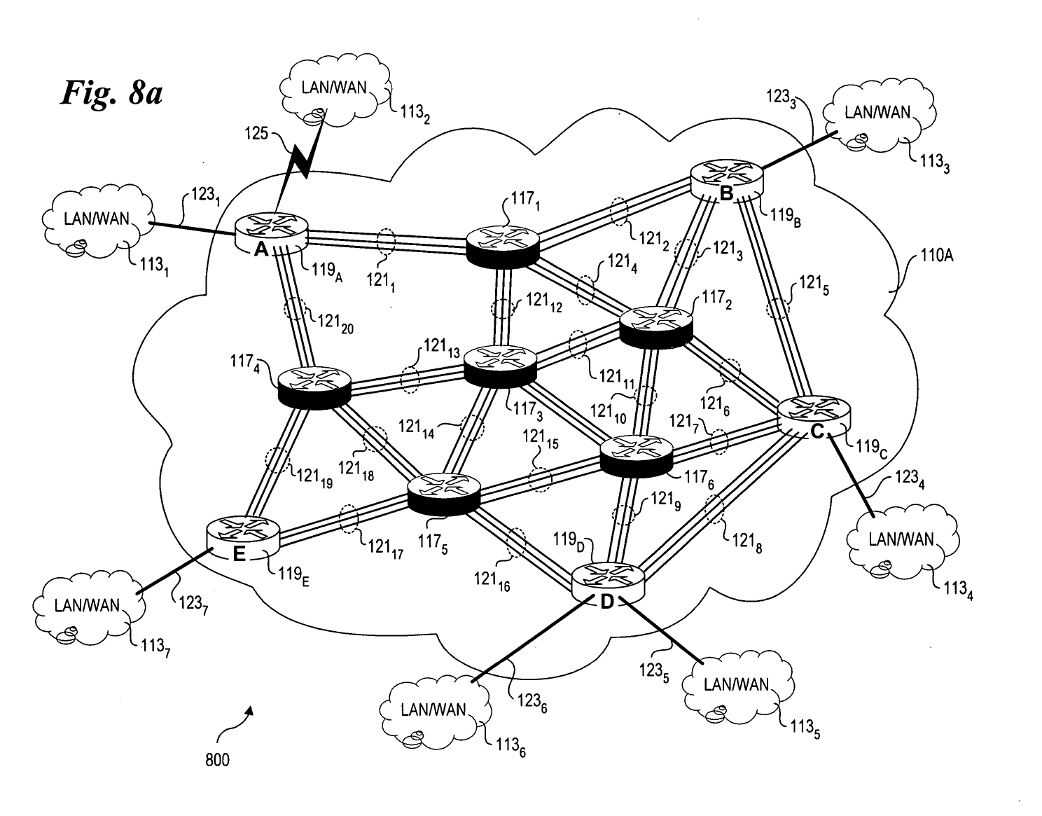

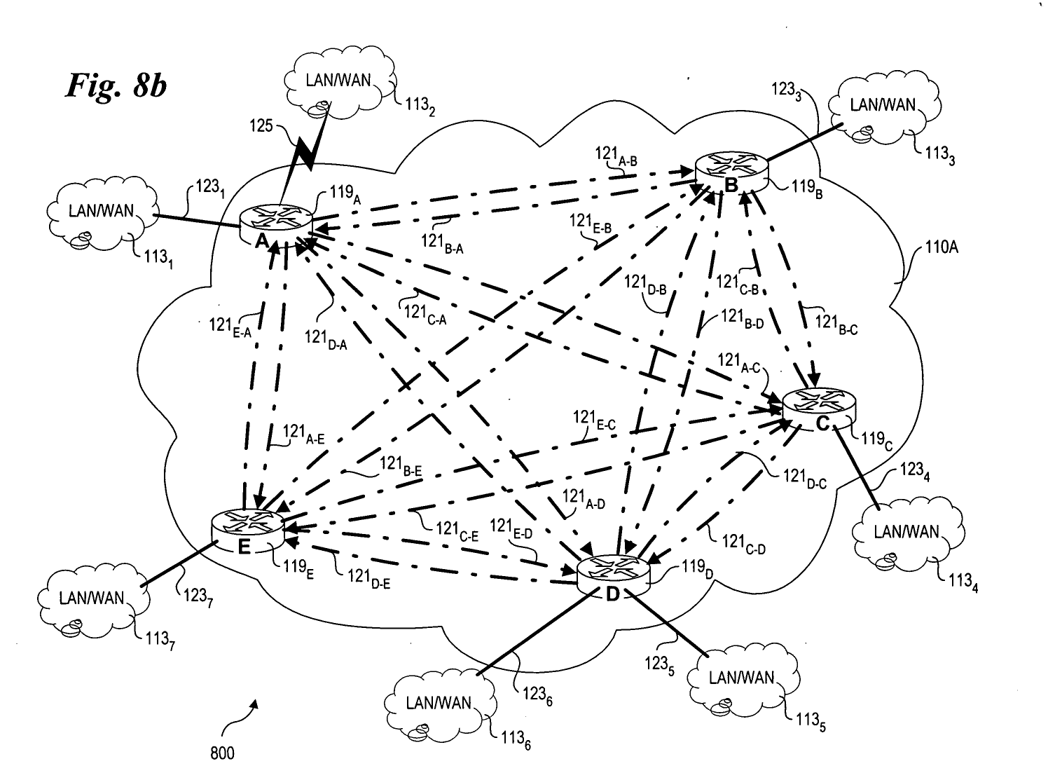

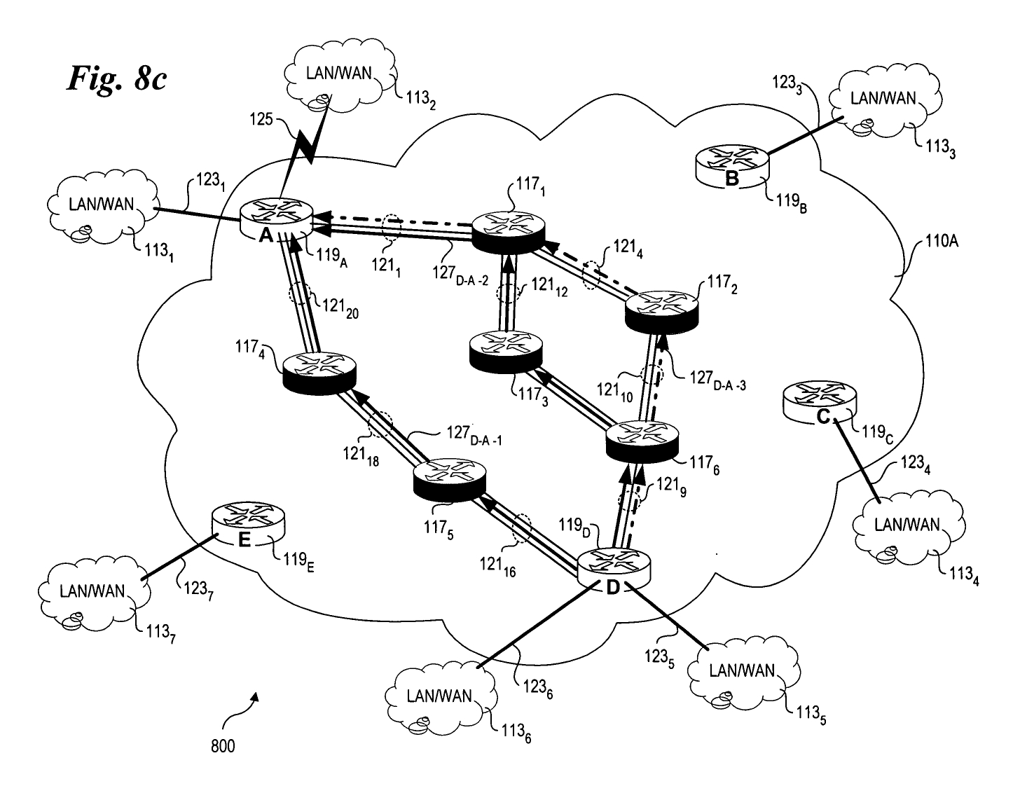

Various levels of details of an exemplary network infrastructure 800 used in conjunction with secure transmission embodiments described below is shown in FIGS. 8a-c. The network infrastructure is centered around a PBS network 110A. The PBS network includes multiple edge nodes 119_{A-E} (labeled A-E for clarity), which are generally interconnected via a plurality of switching nodes 117₁₋₆. Under the construct of PBS network 110 of FIG. 1, a given edge node 119 may function as an ingress node, and egress node, or both (most common). The switching nodes 117 function in the manner discussed above in conjunction with FIG. 1. The various edge nodes 119_{A-E} are connected to external networks 113₁₋₇.

The various edge and switching nodes in PBS network 110A are interconnected via fiber links 121₁₋₂₀. Each of these fiber links are depicted as three lines for illustrative purposes. The three lines represent multiple WDM channels that may shared a common fiber, wherein each of the WDM channels corresponds to a respective wavelength. The number of wavelengths per fiber link will generally be a function of the channel grid spacing and the number of channels selected to be employed. In addition, there may be more than one fiber link between any pair of nodes (not shown).

Each of external networks 113₁₋₇ is connected to an edge node 119 via a respective communication link. These communications links may include an optical or wired link (as shown by physical links 123₁ and 123₃₋₇, or a wireless link, as shown by a wireless link 125. Generally, a given external network 113 may comprise a LAN, WAN, MAN or storage area network (SAN).

From the perspective of the embodiments described below, the particular routes that are employed for given data burst transmissions are substantially irrelevant. From a security perspective, data to be sent as one or more data bursts are encrypted and sent from a first (source) edge node, traverse a virtual lightpath between the first edge node and a second (destination) edge node, whereupon the encrypted data are decrypted. The virtual lightpath comprises a concatenation of hops between the source and destination edge nodes and any switching nodes in-between that are defined by the route. However, from the security perspective, the particular route is generally not considered. Thus, in the following embodiments, all that needs to be known for a given transmission are the source and destination edge nodes.

For clarity, FIG. 8b shows network infrastructure 110A from a security perspective. In this case, the edge nodes 119_{A-E} are connected to each other by various virtual lightpaths 107_{S-D}, wherein subscript S represents a source edge node and subscript D represents a destination edge node. For example, a virtual lightpath from edge node A to edge node B is denoted 127_{A-B}, and so on.

As discussed above, a virtual lightpath generally does not correspond to a specific physical link between source and destination edge node, except in cases in which such links exist, such as fiber link 121₅ between edge nodes C and B in FIG. 8a. For example, FIG. 8c shows three virtual lightpaths between edge nodes D (the source node) and A (the destination node), labeled 127_{D-A-1}, 127_{D-A-2}, and 127_{D-A-3}. As illustrated by each of these virtual lightpaths, a lightpath typically comprises a concatenation of hops between nodes, wherein each hop is defined by a respective lightpath segment. In one embodiment, the entire virtual lightpath employs a common wavelength, as depicted by virtual lightpath 127_{D-A-3}. In other embodiments, the wavelength used for each lightpath segment may vary along the entire lightpath, as illustrated by virtual lightpaths 127_{D-A-1} and 127_{D-A-2}. In some instances, the virtual lightpath will comprise a fiber segment connecting source and destination edge nodes to one another.

In accordance with aspects of the invention, security measures are provided to ensure data transmitted over optical switched networks, such as PBS networks, may not be intercepted or otherwise stolen. In general, the embodiments described below use encryption and decryption schemes to provide data security. In one embodiment, encryption and decryption operations are performed in accordance with public key infrastructure (PKI) principles and rules. The globally-recognized method for secure transactions is to use digital certificates to enable the encryption and digital signing of the exchanged data. The term “public key infrastructure” is used to describe the processes, policies, and standards that govern the issuance, maintenance, and revocation of the certificates, public, and private keys that the encryption and signing operations require.

Public key cryptography allows users of an insecure network, like the Internet, to exchange data with confidence that it will be neither modified nor inappropriately accessed. This is accomplished through a transformation of the data according to an algorithm parameterized by a pair of numbers—the so-called public and private keys. Each participant in the exchange has such a pair of keys. They make the public key freely available to anyone wishing to communicate with them, and they keep the other key private and protected. Although the keys are mathematically related, if the cryptosystem has been designed and implemented securely, it is computationally infeasible to derive the private key from knowledge of the public key.

The nature of the relation between the public and private keys is such that a cryptographic transformation encoded with one key can only be reversed with the other. This defining feature of public key encryption technology enables confidentiality because a message encrypted with the public key of a specific recipient can only be decrypted by the holder of the matching private key (i.e., the recipient, if they have properly protected access to the private key). Even if intercepted by someone else, without the appropriate private key, this third party will be unable to decrypt the message.

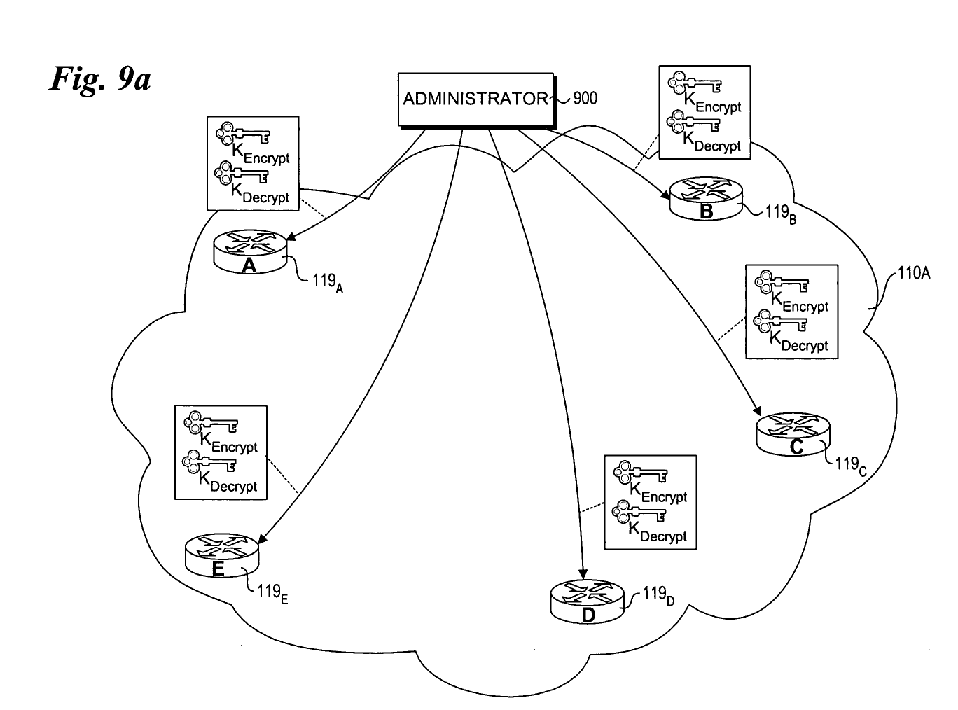

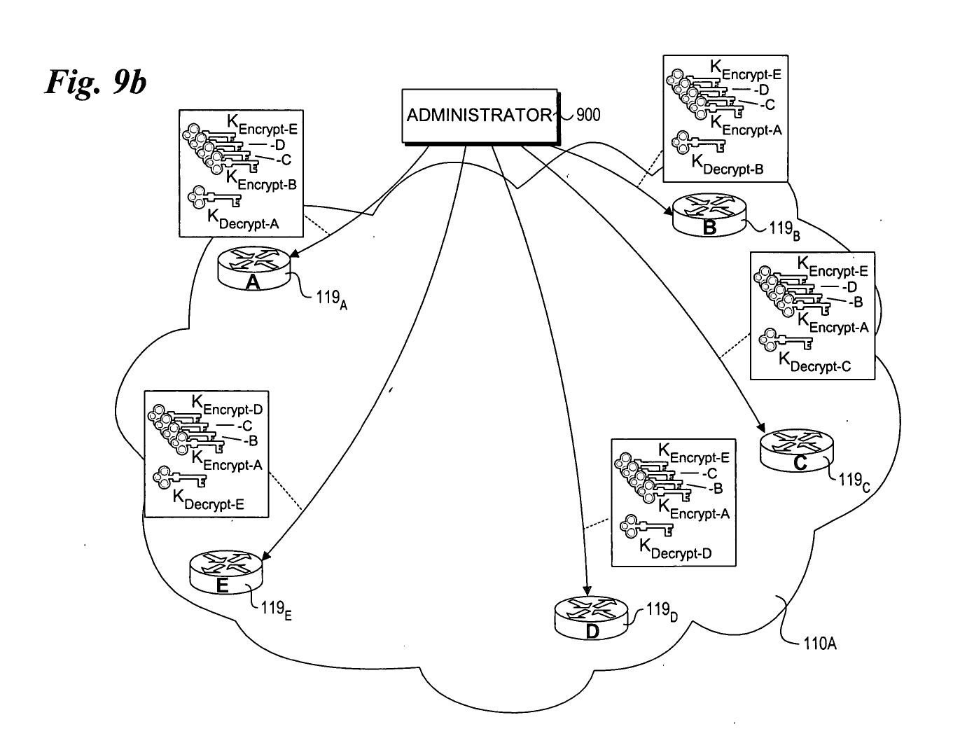

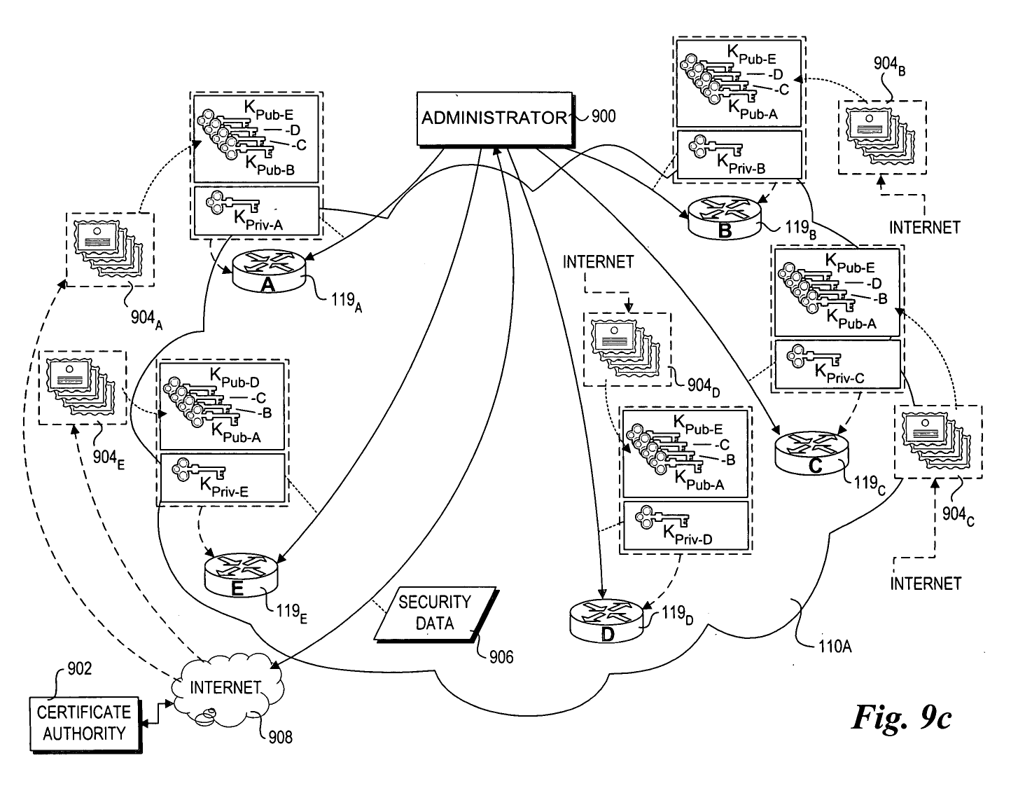

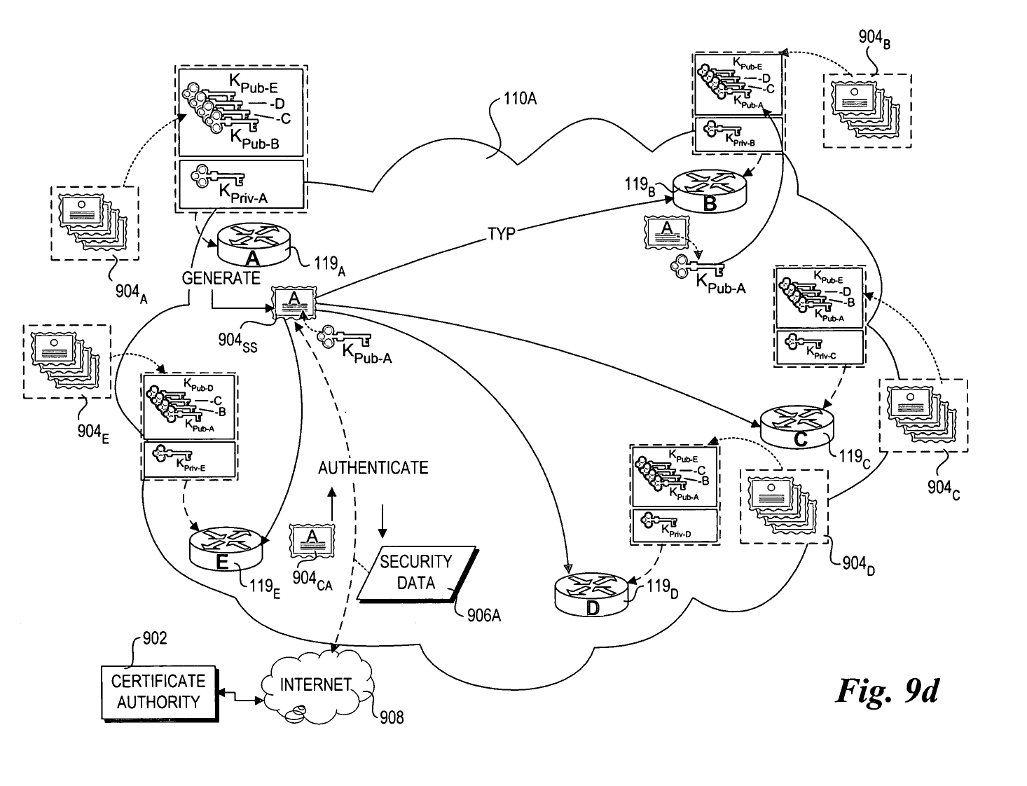

In order to employ encryption-based security measures, there needs to be a mechanism for distributing keys. Each of FIGS. 9a-d show exemplary key distribution schemes in accordance with respective embodiments. The schemes of FIGS. 9a and 9b are analogous to PKI schemes in their use of asymmetrical key pairs, but they do not employ any public infrastructure. The schemes of FIGS. 9c and 9d are implemented via PKI facilities.

In further detail, reference is now made to the key-distribution scheme of FIG. 9a. Under this scheme, a pair of asymmetric keys labeled K_{Encrypt} and K_{Decrypt} are generated or otherwise acquired by a network administrator 900 and distributed to each of PBS edge nodes A-E. Generally, a PBS network will include facilities for managing the various edge and switching nodes. These facilities may typically include an “external” link or “back channel,” such as an Ethernet link, which connects a central administrator server (e.g., operated by administrator 900—not shown) to each of the PBS network nodes. This enables a network administrator to configure and maintain the various network nodes without consuming in-band network resources (i.e., the fiber links used for sending high-speed payload traffic). Optionally, an out-of-band (OOB) channel that employs the PBS network infrastructure may be employed for similar purposes. For example, the OOB channel may use a different wavelength than the in-band channels.

In the embodiment of FIG. 9a, each of PBS edge nodes A-E receives the same pair of asymmetric keys K_{Encrypt} and K_{Decrypt}. These keys are respectively analogous to counterparts K_{Pub} (the public key) K_{Priv} (the private key) of the PKI key pair. The reason for the different nomenclature is that each of keys K_{Encrypt} and K_{Decrypt} are private keys that are never exposed to a public network. Thus, the chance that these keys may be acquired by an outside entity is extremely small. Under this scheme, data are encrypted using key K_{Encrypt} and decrypted using key K_{Decrypt}.

The scheme of FIG. 9b follows the basic private key-pair construct of FIG. 9a, but with each of PBS edge nodes A-E receiving a set of encryption keys K_{Encrypt-i} pertaining to other nodes and a decryption key K_{Decrypt-n} pertaining to that node. For example, edge node A would receive a private decryption key K_{Decrypt-A}, along with private encryption keys for the other edge nodes in PBS network 110A, namely keys K_{Encrypt-B}) K_{Encrypt-C}, K_{Encrypt-D}, and K_{Encrypt-E}. Similar key allotments would be provided to each of edge nodes B, C, D, and E.

The scheme of FIG. 9b provides one notable advantage over the scheme of FIG. 9a. This advantage concerns the ability to prevent destination nodes other than the intended destination node from decrypting the transmitted data. For example, suppose that it is desired to securely send data from edge node A to edge node D. Since edge node D is the destination node, edge node A would select encryption key K_{Encrypt-D} to encrypt the data. The only edge node that holds the asymmetric key to decrypt the data, K_{Decrypt-D}, is edge node D, the intended destination. Thus, if data from edge node A that employs encryption key K_{Encrypt-D} is somehow diverted and sent to any node other that its intended destination node (edge node D), it cannot be decrypted.

The scheme of FIG. 9c is roughly analogous to the scheme of FIG. 9b, except this time public key infrastructure facilities are used. Private keys that are analogous to the private decryption key K_{Decrypt} of FIG. 9a and keys K_{Decrypt-n}, of FIG. 9b are distributed by administrator 900 to each of edge nodes A-E in a manner similar to that described above. However, this time the asymmetrical keys are public keys (K_{Pub-n}) that are distributed via digital certificates 904_{A-E}.

In their simplest form, digital certificates, which are also referred to as “authentication certificates,” contain a public key and a name. As commonly used, a digital certificate also contains an expiration date, information identifying the certifying authority that issued the certificate (e.g., certificate authority 902), a unique identifier (e.g., serial number), and perhaps other information. Importantly, a digital certificate also contains a digital signature of the certificate issuer. The most widely accepted format for certificates is defined by ITU (International Telecommunications Union)-T X.509 international standard. Accordingly, in one embodiment digital certificates 904_{A-E} comprise ITU-T X.509 certificates.

In one embodiment of the FIG. 9c scheme, the certificate issuer is administrator 900. The administrator generates self-signed digital certificates and distributes them to the edge nodes A-E. In another embodiment, the digital certificates are authenticated by a certificate authority. The administrator 900 sends security data 906 along with the digital certificate information (e.g., a public key or keys, attestation information, etc.) to the certificate authority 902. Generally a certificate authority (CA) is a trusted third party that provides certificate authentication services. The CA does not generate public keys, but rather provides authentication information relating to public keys via issuance of certificates containing those keys, along with other attestation data.

Another function performed by a CA, or another trusted third party, is certificate validity. In general, certificates issued by CA's carry an expiration date. This is to ensure that a given public key is in the public domain for a limited duration. Accordingly, a first validity check is to check the expiration date on the certificate to verify it has not expired. At the same time, certificates may be revoked for one or more reasons. Since certificates may be widely distributed, there is no feasible mechanism for directly apprizing a certificate owner that a certificate has been revoked. One way this problem is addressed is by providing an Internet site (e.g., Verisign) that hosts a certification revocation list. This list can be checked by a client to verify a certificate has not been revoked. In one embodiment, this may be performed by either administrator 900 or any of edge nodes A-E on a periodic basis.

Although FIG. 9c depicts digital certificates 904_{A-E} as being provided to edge nodes A-E via Internet 908, this is not meant to be limiting. In other embodiments, the digital certificates may be returned to administrator 900 and then individually distributed to the appropriate edge nodes. In yet another embodiment, administrator 900 extracts public key and possibly other information (e.g., a digital signature) and provides this information to the appropriate edge nodes.

Once the keys are distributed, the operation of the embodiment of FIG. 9c is analogous to that discussed above in conjunction with FIG. 9b. More specifically, a public key K_{Pub-n} is selected based on the destination node, and data are encrypted using that node. At the destination end, the corresponding private key (K_{Priv-n}) held by the destination edge node is used to decrypt the encrypted data.

Yet another key distribution scheme is shown in FIG. 9d. It shall be recognized that the keys sets ultimately provided to each of edge nodes A-E are the same in each of embodiments 9c and 9d. However, they generation and distribution scheme is different.

Under the embodiment of FIG. 9d, the private (or encryption) and public (or decryption) keys are generated by each respective edge node A-E. In one embodiment, an encryption key is generated and held by the key-generating edge node, while the corresponding asymmetric decryption key is forwarded to each of the other edge nodes. For example, edge node A would generate an encryption key K_{Encrypt-A}, which it would hold, and a decryption key K_{Encrypt-A}, which it would distribute to the other edge nodes. As before, the key distribution scheme may employ an external link or an OOB channel. The other edge nodes would perform similar operations.

In another embodiment based on the foregoing general key distribution technique, PKI-based security measures are employed. In this instance, as illustrated in FIG. 9d, each edge node generates a self-signed X.509 digital certificate 904_{SS}, or obtains an authenticated X.509 digital certificate 904_{CA} by first passing corresponding security data 906A to certificate authority 902 and receiving the authenticated X.509 certificate. As before, the certificate includes a public key K_{Pub-n} corresponding to and asymmetric with the private key the K_{Priv-n} held by the edge node that generated the key pair. Similar activities are performed for each of the other edge nodes, such that each edge nodes ends up holding its own private key and a set of public keys respectively corresponding to each of the other edge nodes.

Details of an extended header 1000 employed by one embodiment as a mechanism for distributing security data via an OOB channel are shown in FIG. 10. The existence of an extended header is indicated by having the extended header (EH) field 606 off the generic PBS frame 500 set to “1” (FIGS. 5 and 6). The extended header 1000 includes a Command field 1002, a reserved (R) field 1004, a PAD field 1006, a Length field 1008 and extended header data 1010. The Command field 1002 identifies the Command carried by the extended header 1000, as described below. In the illustrated embodiment, the Command field is 12 bits.

The reserved field 1004 comprises a 1-bit field that is reserved for future use.

The PAD field 1006 identifies the number of padding byes that might be necessary to pad the last word of the extended header to comprise a 32-bit word. In the illustrated embodiment, PAD field 1106 comprises 3 bits.

The Length field 1008 defines the length of extended header 1000 in (32-bit) words, including the Command/Length word of the extended header. The minimum length is “1”, which corresponds to cases in which commands are provided that do not include any associated data (i.e., extended header data 1010).

The extended header data 1010 comprises a variable-length field (as defined by the Length field 1008) and may include up to three bytes of padding. In general, the extended header data will include security data, such as encryption and/or decryption keys 1012 (either symmetric or asymmetric) or data from which a decryption key can be derived. For example, in one embodiment the security key itself is encrypted using an encryption key known to a particular destination edge node or all of the edge nodes in a given PBS network. In this embodiment, even if the decryption key is somehow stolen, the acquiring entity will not be able to decrypt the data contained in the data bursts that are subsequently forwarded along the route reserved by the control burst.

In one embodiment, extended header data 1010 further includes data indicating the encryption algorithm that was employed to encrypt the data, as depicted by an encryption algorithm field 1014. For instance, a decryption key is useless if the encryption algorithm isn't known. For PKI encryption, the RSA encryption algorithm is most commonly used. Other encryption algorithms may also be used, including but not limited to the DES (Data Encryption Standard) algorithm (56-bit key), DES3 (Triple DES), RC2-40, RC2-64 and RC2-128 algorithms (40-, 64-, and 128-bit, respectively), RC4 algorithms, AES (Advanced Encryption Standard) algorithms, MD5 (Message Digest Algorithm) and SHA-1 (Secure Hash Algorithm). Furthermore, proprietary encryption schemes may also be employed. For implementations under which the encryption algorithm is known in advance, the encryption algorithm field 1014 may be dropped.

In general, encryption and decryption operations may be performed by software algorithms running on a processing core (e.g., a general-purpose processor or a network processor, for example), or may be performed via hardware that is programmed to perform the algorithms. In the case of software-based algorithms, the code for the algorithm may be provided by encryption algorithm 1014, or encryption algorithm 1014 may be used to identify the algorithm to be used, as described below in further detail.

FIG. 11 shows a flowchart including operations performed to securely transmit data across a PBS network, according to one embodiment. The process involves two phases: a setup phase that is performed first, and than a subsequent ongoing phase.

The setup phase is used to provide appropriate keys and optional additional security data, such as algorithm code, to each of the edge nodes in the PBS network, and to set up the edge nodes to use these data. Accordingly, in a block 1100 the keys and optional security data are distributed to the edge nodes. In different respective embodiments, the distribution schemes of FIGS. 9a, 9b, 9c and 9d are employed. For distribution schemes that employ external links (e.g., Ethernet), the various data are encapsulated in the forwarding data structures used by the network protocol, such as packets or Ethernet frames. For distribution via a PBS network OOB channel, the data are forwarded using control burst that include extended header 1000, wherein the security data are included in extended header data 1010. In addition to these schemes, any suitable scheme for distributing asymmetric key pairs may be employed.

Once the keys and optional security data are received at a given edge node, corresponding data are stored on that node. For example, in one embodiment the data are stored in memory. In another embodiment, the data are stored in a non-volatile (NV) store, such as a flash device or a local mass storage device. Other setup operations may also be performed, such as setting up pointers to the locations of the keys.

The remaining operations shown in FIG. 11 related to ongoing operations that may be performed after the setup operations have been completed. First, in a block 1104, the data to be transmitted across the PBS network are received at a source edge node. The data are then classified and processed in the manner described above, as depicted by a block 1106. In a block 1108, an appropriate encryption key for the destination node is selected. In the embodiment of FIG. 9a, there is only a single key that is used by all nodes for encryption, so this key is selected. In the embodiments of FIGS. 9b, 9c, and 9d, there is an encryption key (i.e., K_{Encrypt-n} or K_{Pub-n}) that is stored at each edge node that is particular to the destination node; in this case, that particular encryption key is selected.

After the encryption key is selected, it is used to encrypt the data in a block 1110. The encrypted data is then passed to the ingress PBS MAC layer to be processed in the same manner discussed above for “regular” data. That is, from the perspective of the PBS MAC layer, encrypted and non-encrypted data are indistinguishable. Accordingly, the operations performed by the PBS MAC layer are the same as before. These include building a control burst in a block 1114. The control burst is used to reserve network resources to support all of the lightpath segments (i.e., hops) along a virtual lightpath for a future variable-length timeslot. The control burst may also contain information identifying whether or not the following associated data burst are encrypted or not, and what decryption algorithm is to be used (if a default algorithm is not employed or is not known in advance). For example, in one embodiment the DE field 520 of generic PBS frame 500 is asserted (e.g., marked with a “1”) to indicate the control burst contains security-related data (i.e., encryption will be enabled for the corresponding data bursts) or for security data distribution purposes.

In a block 1116, the encrypted data are assembled into one or more data bursts, as needed. In one embodiment, generation of data bursts coincides with generation of the corresponding control burst, wherein the operations of blocks 1114 and 1116 are performed together. One or more data bursts are sent from the source edge node to the destination edge node based on the selected scheduling algorithm and the reserved lightpath resources. The received data burst(s) is/are then de-framed and de-multiplexed in a block 1120, yielding the encrypted data. The encrypted data is then decrypted with the destination nodes decryption key and identified algorithm (or default algorithm) in a block 1122.

The hardware for performing the various operations for the edge nodes discussed above, may be embodied in one of many different platform configurations. For example, in one embodiment one or more server modules are housed within a server unit, such as a blade server or the like. In another embodiment, all of an edge node's functionality may be provided by a single card or server module.

For example, FIG. 12a illustrates optical PBS I/O module 1200, according to one embodiment of the present invention. In this embodiment, optical PBS I/O module 1200 includes a network processor unit 1202 (this module could have multiple network processors), a bus bridge 1204, a queue unit 1206, a framer unit 1208 (having framer and de-framer functions as indicated by blocks 1208, and 12082), an E-O interface 1210, an O-E interface 1216, a network processor buffer 1220, a traffic shaper 1224 and a traffic shaper buffer 1226. PBS I/O module 1200 further includes a backplane switching fabric 1230, which in one embodiment comprises a PCI Express bus, although any other suitable buses may be used in other embodiments. Thus, bus-bridge 1204 can be implemented using a commercially available PCI bridge device or chip set.

In the illustrated embodiment, the foregoing elements of optical PBS I/O unit 1200 are interconnected as follows. Bus bridge 1204 is connected to backplane switching fabric 1230 to support parallel bidirectional traffic via interconnect 1238. Bus bridge 1204 is also connected to traffic shaper 1224 via an electrical interconnect 1239. Electrical interconnects 1238, 1239 and other signal interconnects in FIG. 12a are depicted as single interconnect wire (even though the connection may include several signal interconnect wires) for clarity.

Traffic shaper 1224 is connected to network processor unit 1202 and buffer 1226 via interconnects 1240 and 1241, respectively. Network processor unit 1202 is connected to queue unit 1206 and buffer 1220 via interconnects 1242 and 1243, respectively. Queue unit 1206 is in turn connected to PBS framer/de-framer unit 1208 via an interconnect 1244.

As shown in FIG. 12b, in some embodiments network processor unit 1202 includes an ingress network processor 1260 and an egress network processor 1262. Thus, in some embodiments of optical PBS I/O module 1200, interconnects 1240 and 1242 are connected to ingress network processor 1260.

Further, as shown in FIG. 12b, in some embodiments, queue unit 1206 can include data queues 1270 and 1272, control queues 1274, and 1275 and an electrical switch or demultiplexer 1276 coupled to the output ports of queues 1270, 1272, 1274 and 1275. Thus, in some embodiments, the input ports of queues 1270, 1272, 1274 and 1275 are connected to interconnect 1242 via a switch or multiplexer (not shown). In addition, in some embodiments, the output port of switch 1276 can be connected to interconnect 1244.

In other embodiments, a different number of processors (e.g., a single processor) can be used in network processor unit 1202. Further, in some embodiments, a different number of queues can be used in queue unit 1206. For example, queue unit need not include a dedicated control queue and/or two data queues. Multiple queues can be used to provide storage for building multiple bursts with different properties such as different priorities. In general, buffers 1220 and 1226 will be embodied as some form of memory, such as dynamic random access memory (DRAM) or static random access memory (SRAM).

Referring again to FIG. 12a, PBS framer unit 1208 is connected to E-O interface 1210 via an interconnect 1246. E-O interface 1210 is in turn is connected to the rest of a PBS network via an interconnect 1248. O-E interface 1216 connected to the rest of the PBS network via a interconnect 1250. In general, O-E interface 1216 can receive all the transmitted wavelengths on an interconnected external network, such as a server and/or storage area network (SAN)—either it has a tunable optical burst receiver or multiple fixed wavelength optical burst receivers. O-E interface 1216 is also connected to framer unit 1208 via an interconnect 1252. Framer unit 1208 is also connected to network processor unit 1202 via a interconnect 1254. In one embodiment, an interconnect 1264 is connected to network processor 1262 (FIG. 12b). Network processor unit 1202 is connected to bus bridge 1204 via an interconnect 1256. The operation of optical PBS I/O module 120 in transferring information to and from the PBS network is described below in conjunction with FIGS. 13 and 14.

Referring to FIGS. 12a-b and a flowchart 1300 of FIG. 13, optical PBS I/O module 1200 performs PBS egress operations (i.e., transferring information from the PBS network to a legacy network and/or server module of a server unit) as follows. Optical PBS I/O module 1200 converts an optical PBS burst received from the PBS network via an interconnect 1250 into electrical signals. In this embodiment, O-E interface 1216 performs the O-E conversion. This operational flow is represented by a block 1302.

The received O-E converted PBS burst is then de-framed and de-multiplexed. In this embodiment, framer unit 1208 receives the O-E converted PBS burst from O-E interface 1216 via interconnect 1252 and de-frames the PBS burst. For example, in one embodiment, the PBS burst may be framed as described above with reference to FIGS. 5 and 6. In other embodiments, a different framing format may be used. De-multiplexing enables each framed data burst to be separated into the corresponding IP packets, Ethernet fames, Fiber Channel (FC) frames, etc. This operational flow is represented by a block 1304.

The information included in the PBS burst is then processed. In this embodiment, network processor unit 1202 receives the de-framed and de-multiplexed PBS burst from framer unit 1208 via interconnect 1254 and performs the processing. For example, in some embodiments, network processor unit 1202 can extract address and payload information, perform error correction on header and/or payload information, concatenate a payload, re-assemble segmented payloads, etc. Network processor unit 1202 can use buffer 1220 to temporarily store information during the above processing operations. In one embodiment, egress network processor 1262 (FIG. 12b) processes the de-framed burst.

Another aspect of processing is decryption. As discussed above; this can be performed by software executing on a processor or the like such as network processor unit 1202. Optional, this may be performed by dedicated hardware. Both embodiments are depicted as a decryption block 1270 in FIG. 12b. The processing and decryption operations are represented by a block 1306.

The processed and decrypted information is then transmitted over backplane switching fabric 1230. In one embodiment, bus bridge 1204 receives the processed information from network processor unit 1202 via an interconnect 1256 and transmits the information over backplane switching fabric 1230 to the proper destination, in the proper format, and with proper bus control signals (e.g., according to the PCI protocol). The destination for the information may be, for example, a device connected to the legacy network (in which case the information is transmitted to a legacy interface module not shown or a server module (both not shown)). For example, a legacy interface might comprise an Ethernet NIC or a Fiber Channel interface. This operational flow is represented by a block 1308.

Referring to FIGS. 12a-b and a flowchart 1400 of FIG. 14, optical PBS I/O module 1200 performs PBS ingress operations; i.e., transferring information to the PBS network from a legacy network and/or server module of a server unit as follows. Optical PBS I/O module 1200 receives information to be transmitted over a PBS network in the form of electrical signals. In one embodiment, bus bridge 1204 receives the information from backplane switching fabric via an interconnect 1238. In this embodiment, this information can come from the legacy network via a legacy interface or from one of various server modules (both not shown). This operational flow is represented by a block 1402.

The received information is then shaped to help improve traffic flow in the PBS network (e.g., PBS network 110 of FIG. 1). In this embodiment, traffic shaper 1224 receives the information from bus bridge 1204 via interconnect 1239 and shapes the information. For example, in one embodiment, traffic shaper 1224 performs operations on the information to reduce the correlation structures and long-term dependence of the incoming traffic flows caused by the self-similarity effect. Traffic shaper 1224 can be configured to perform any suitable traffic-shaping algorithm or technique known in the art. Traffic shaper 1224 can use buffer 1226 to temporarily store information while performing traffic shaping operations. This operational flow is represented by a block 1404.

The shaped information is then multiplexed into PBS control and data bursts. In this embodiment, network processor unit 1202 receives the shaped information from traffic shaper 1224 via interconnect 1240. Network processor unit 1202 then processes the information to form and schedule PBS control and data bursts as described above for ingress nodes in PBS network 10A. In other embodiments, the information is assembled into suitable burst sizes based on the selected burst assembly algorithms to be transmitted over an optical burst network (not necessarily a PBS network). In one embodiment, ingress network processor 1260 (FIG. 12b) processes the traffic shaped information. Further, in this embodiment, network processor unit 1202 uses queue unit 1206 to store the control and data bursts as they are being formed and until they are scheduled for transmission over the PBS network. This operational flow is represented by a block 1406.

Another aspect of the operational flow of block 1406 relates to security operations. For instance, this includes data encryption for the data payload and formatting the PBS burst to identify whether encryption is used in the associated data burst, what algorithm to employ, etc. As with data decryption, data may be encrypted using a software-based algorithm or may be performed using an appropriately programmed hardware device. Both of these embodiments are depicted as an encryption block 1272.

The encrypted data bursts are then encapsulated into frames for transmission over the PBS network. In this embodiment, framer unit 1208 receives the bursts from queue unit 1206 via interconnect 1244 and performs the framing operation. In one embodiment, the bursts are framed as described above with reference to FIGS. 5 and 6. In other embodiments, different framing formats can be used. This operational flow is represented by a block 1408.

The framed bursts are then converted to optical signals and transmitted over the PBS network at the scheduled times. In this embodiment, E-O interface 1210 receives the framed bursts (i.e., PBS control and data bursts) from framer unit 1208 via interconnect 1246. E-O interface 1210 then performs the E-O conversion and transmits the optical signals at the scheduled time and in the reserved PBS TDM channel of the PBS network. This operational flow is represented by blocks 1410 and 1412.

In general, the encryption/decryption functionality may be provided by a separate module (as depicted by decryption block 1270 and encryption block 1272 in FIG. 12b), or may be integrated onto an existing component of PBS architecture 400 (FIG. 4). As with the foregoing PBS switching node and edge node functionality, the encryption/decryption functionality can be implemented via hardware (e.g., programmed logic), software, or a combination of the two. More specifically, software for implementing PBS switching node and edge node functionality may be embodied as one or more sets of instructions or modules including instructions that are executed on some form of processor core, such as a network processor, processor of a server or I/O module, or other type of processor. In addition, the code (i.e., instructions) corresponding to such software will generally be loaded into memory prior to execution. Furthermore, during ongoing operations the instructions may be stored in a processor cache, or a secondary cache.

Thus, embodiments of this invention may be used as or to support software program executed upon some form of processing core or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

In the foregoing specification, embodiments of the invention have been described. It will, however, be evident that various modifications and changes may be made thereto without departing from the broader spirit and scope as set forth in the appended claims. The specification and drawings are, accordingly, to be regarded in an illustrative rather than a restrictive sense.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method for securely transferring data across an optical-switched (OS) network, comprising:
distributing security keys to edge nodes in the OS network;
encrypting, at a source edge node, data to be sent from the source edge node to a destination edge node, said data encrypted with a security key distributed to the source node;
sending the data along a virtual lightpath between the source and destination edge nodes, the virtual lightpath spanning at least one lightpath segment; and
decrypting, at the destination edge node, the encrypted data that are sent.

2. The method of claim 1, wherein the OS network comprises an optical burst-switched (OBS) network.

3. The method of claim 2, wherein the OBS network comprises a photonic burst-switched (PBS) network.

4. The method of claim 2, wherein the PBS network comprises a wavelength-division multiplexed (WDM) PBS network.

5. The method of claim 1, wherein the security keys are distributed by distributing a common decryption and encryption key pair to each of the edge nodes.

6. The method of claim 1, wherein the security keys are distributed by:
distributing a respective decryption key to each of the edge nodes, each respective decryption key being particular to its node; and
distributing respective sets of encryption keys to each node, each set of encryption keys for a given node including encryption keys corresponding to the decryption keys distributed to each of the other edge nodes.

7. The method of claim 1, wherein the security keys are distributed by:
distributing a respective private key to each of the edge nodes, each respective private key being particular to its node; and
distributing respective sets of digital certificates sets to each node, each set of digital certificates for a given node containing a set of public keys corresponding to the private keys distributed to each of the other edge nodes.

8. The method of claim 6, further comprising self-generating the digital certificates.

9. The method of claim 8, further comprising:
for each edge node,
self-generating an digital certificate containing a public key that is asymmetric to the private key for the edge node; and
sending the digital certificate to each of the other edge nodes.

10. The method of claim 9, further comprising:
for at least one node,
generating a private key for the edge node via key-generation facilities provided by the edge node; and
generating the public key for the edge node via the key-generation facilities.

11. The method of claim 7, further comprising:
sending security data to a certificate authority, the security data defining public keys that are to be included in respective digital certificates; and
receiving authenticated digital certificates from the certificate authority.

12. The method of claim 11, wherein the security data is sent from an administrator of the OBS network.

13. The method of claim 9, further comprising:
generating a respective set of security data at each edge node; and
sending the respective set of security data from each edge node to the certificate authority.

14. The method of claim 1, further comprising sending security keys to the edge nodes using a communication channel that is external to the OBS network to distribute the security keys.

15. The method of claim 1, further comprising sending security keys to the edge nodes using an out-of-band channel of the OBS network to distribute the security keys.

16. The method of claim 15, further comprising sending security data via a control burst for the OBS network, the security data including one or more security keys or containing information from which one or more security keys can be derived.

17. The method of claim 1, further comprising sending information to each edge node identifying at least one of an encryption algorithm and decryption algorithm to be employed to encrypt and/or decrypt the data via the security keys.

18. The method of claim 17, further comprising sending encryption and/or decryption code to an edge node, the encryption and/or decryption code to be executed to perform encryption and/or decryption operations.

19. A machine-readable medium to provide instructions, which when executed by a processor in a source edge node of an optical switched (OS) network cause the source edge node to perform operations including:
encrypting data to be sent to a destination edge node;
generating a control burst, the control burst containing information to reserve network resources to form a virtual lightpath between the source edge node and the destination edge node during a scheduled timeslot, the virtual lightpath including at least one lightpath segment;
embedding information in the control burst identifying one or more data bursts to be sent from the edge node to the destination edge node will be encrypted;
sending the control burst to a first hop along the virtual lightpath, the first hop comprising one of a switching node or the destination edge node; and
sending said one or more data bursts containing the data that are encrypted to the first hop along the virtual lightpath during the scheduled timeslot.

20. The machine-readable medium of claim 19, wherein execution of the instructions further perform the operation of sending an encryption key to each of a plurality of edge nodes in the OS network.

21. The machine-readable medium of claim 20, wherein execution of the instructions performs the operation of sending the encryption key to an edge node by:
generating a control burst containing security data including the encryption key or data from which the encryption key can be derived; and
sending the control burst to a first hop along a virtual lightpath coupling the edge node sending the control burst to and edge node receiving the control burst, the first hop comprising one of the edge node receiving the control burst or a switching node.

22. The machine-readable medium of claim 21, wherein the security data include an digital certificate.

23. The machine-readable medium of claim 22, wherein execution of the instructions performs the further operation of generating a self-signed digital certificate.

24. The machine-readable medium of claim 21, wherein the security data include one of information identifying an encryption algorithm used to encrypt the data or executable code that may be used to decrypt the certificate.

25. The machine-readable medium of claim 20, wherein an encryption key is sent to an edge node via a communication channel that is external from the OS network.

26. The machine-readable medium of claim 19, wherein execution of the instructions performs further operations including:
generating an encryption key, the encryption key to be used to encrypt the data; and
generating a decryption key corresponding to the encryption key.

27. The machine-readable medium of claim 19, wherein execution of the instructions performs further operations including:
generating security data including the decryption key and identifying the decryption key as a public key, the security data comprising data from which an digital certificate may be issued; and
sending the security data to a certificate authority.

28. A system comprising:
at least one processor;
memory coupled to said at least one processor;
an encryption component;
an optical interface; and
a storage device in which instructions are stored, said instructions to perform operations when executed by said at least one processor, including:
invoking the encryption component to encrypt data to be sent to a destination edge node operatively linked in communication to the system via a photonic burst-switched (PBS) network, the system to operate as a source edge node;
generating a control burst, the control burst containing information to reserve PBS network resources to form a virtual lightpath between the source edge node and the destination edge node during a scheduled timeslot, the virtual lightpath including at least one lightpath segment;
embedding information in the control burst identifying one or more data bursts to be sent from the source edge node to the destination edge node will be encrypted;
sending the control burst to a first hop along the virtual lightpath, the first hop comprising one of a switching node or the destination edge node; and
sending said one or more data bursts containing the data that are encrypted to the first hop along the virtual lightpath during the scheduled timeslot.

29. The system of claim 28, wherein said at least one processor includes a network processor.

30. The system of claim 29, wherein said at least one processor includes an ingress network processor and an egress network processor.

31. The system of claim 30, wherein the encryption component comprises a hardware device programmed to perform encryption operations.

32. The system of claim 30, wherein the encryption component is embodied as a software module comprising a plurality of instructions to effectuate encryption operations when executed on a processor.

33. The system of claim 28, further comprising a decryption component configured to decrypt data received from the PBS network.

34. The system of claim 33, wherein the decryption component comprises a hardware device programmed to perform decryption operations.

35. The system of claim 33, wherein the decryption component is embodied as a software module comprising a plurality of instructions to effectuate decryption operations when executed on a processor.

36. The system of claim 28, further comprising a key generation component.

37. The system of claim 36, wherein the key generation component comprises a hardware device programmed to generate security keys.

38. The system of claim 36, wherein the key generation component is embodied as a software module comprising a plurality of instructions to effectuate generation of security keys.
